(19) United States
(12) Patent Application Publication
(10) Pub. No.: US 2007/0074250 A1
(43) Pub. Date: Mar. 29, 2007

(54) Sub-contents reproducing apparatus and contents related service providing system

(75) Inventor: Hirofumi Furukawa, Chiba-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/236,689

(22) Filed: Sep. 28, 2005

(51) Int. Cl. H04N 5/445; H04N 7/173

(52) U.S. Cl. 725/40; 725/116

(57) ABSTRACT

A sub-contents reproducing apparatus capable of executing some process associated with contents, at a highly reliable timing while preventing unfair treatment among users includes a sub-contents storing unit for obtaining and storing the sub-contents simultaneously with or before distribution of the corresponding sub-contents control information, an associated data receiving unit for obtaining sub-contents control information prepared for broadcast contents when broadcast contents are reproduced, and a sub-contents reproduction control unit responsive to the associated data receiving unit obtaining the sub-contents control information, for executing reproduction control corresponding to the sub-contents control information on the sub-contents stored in the sub-contents storing unit.

### BACKGROUND OF THE INVENTION

1. Field of the Invention

The present invention relates to a service providing system providing services in association with contents such as broadcast, and more specifically, the present invention relates to a sub-contents reproducing apparatus and a service providing system for reproducing sub-contents related to the contents.

2. Description of the Background Art

At present, TV (television) broadcast is in the process of transition from analogue broadcast to digital broadcast. Main characteristics of digital broadcast include large number of channels, high image quality, and high sound quality, and the capability of broadcasting data other than the broadcasted contents. The broadcasting of data will be hereinafter referred to as “data broadcast”.

In data broadcast, data such as texts, programs and the like are distributed to an unspecified number of terminals (TV receivers). The medium is radio wave of satellite TV broadcast or terrestrial TV broadcast. Therefore, data broadcast is provided by a broadcasting operator. By utilizing data broadcast and information input and communication functions of a terminal, bi-directional (interactive) service becomes possible, by which a viewer of TV broadcast can react in some way or another.

In a conventional bi-directional service, AV (audio visual) contents and sub-data associated with the AV contents are transmitted to a terminal. The sub-data include BM data described in BML (Broadcast Markup Language). Receiving the sub-data, the terminal interprets and executes the sub-data, and as a result, broadcast contents or associated piece of information are laid-out and displayed by the terminal. The interaction by the input at the terminal is realized by an ECMAScript, which is included in the BML data. The data including the input contents are transmitted under the control in accordance with the ECMAScript, through a telephone line and the Internet to a BML response server or the like and processed therein.

There is also an interactive service in which the terminal has sub-contents intended to be linked to the broadcast. Here, it is necessary to use the sub-contents on the terminal to be linked to the broadcast contents in the intended manner.

An interactive advertising apparatus providing such a service is disclosed in Japanese Patent Laying-Open No. 2003-308035. The interactive advertising apparatus distributes to a user a message including a piece of information to be presented to the user in synchronization with the TV advertisement, in advance. The message includes the scheduled time of distribution of the advertisement. The terminal has a timer, and when it comes to the time of broadcast of the advertisement in the distributed message, a process in accordance with the message is activated.

Japanese Patent Laying-Open No. 9-93551 discloses an interactive text broadcasting system used for a quiz program and the like in which participants compete on the speed of answering. In this system, a broadcasting station broadcasts a prescribed code incorporated in pieces of broadcast information. When a terminal (such as a remote controller of a TV receiver) receives the code, a counter in the terminal starts counting the elapsed time. The terminal measures the elapsed time until a user presses a prescribed button. The terminal transmits the measured time to a prescribed address. It is described in Japanese Patent Laying-Open No. 9-93551 that the prescribed code may be distributed included in the broadcast information or separate from the broadcast information.

In the apparatus described in Japanese Patent Laying-Open No. 2003-308035, the time as a trigger of the process in accordance with the message may differ from the intended time if the timer in the terminal is modified. Therefore, distribution of the interactive advertisement using this apparatus is not very reliable. It may be possible to change the design of the apparatus of Japanese Patent Laying-Open No. 2003-308035 such that the prescribed code included in the broadcast information is used as a trigger as suggested in Japanese Patent Laying-Open No. 9-93551. By doing so, the message can be activated at a prescribed time. When a process of measuring elapsed time from activation is to be done by a timer within the terminal, however, the measured time information is not very reliable, as it depends on performance of the terminal or delay in the distributing path.

Further, in the apparatus described in Japanese Patent Laying-Open No. 2003-308035, time information is embedded in the message. On the other hand, there is a one-to-one relation between the message and the broadcast. Assuming that one broadcast program has a plurality of interactive advertisement messages, the user must have a plurality of messages in his/her terminal, which would consume much resource of the terminal.

In the system described in Japanese Patent Laying-Open No. 9-93551, a counter in the terminal is activated in response to a prescribed code, and by the counter value, the elapsed time up to the user operation is obtained. The elapsed time is transmitted to a prescribed destination. Therefore, there would not be any unfair treatment among users caused by possible delay over the distribution path. If the counter function of the terminal is modified, however, reliability of the result would be lost as in the apparatus of Japanese Patent Laying-Open No. 2003-308035.

Therefore, an object of the present invention is to provide, in a system of providing sub-contents related to main contents provided by broadcasting service, a sub-contents reproducing apparatus and a contents related service providing system that can execute some process in accordance with the sub-contents to be provided to the user, at a highly reliable timing while preventing unfair treatment among users.

### SUMMARY OF THE INVENTION

A sub-content reproducing apparatus in accordance with the first aspect of the present invention is for reproducing, in association with first contents as a main object, prescribed sub-contents related to the first contents. Sub-contents control information for designating reproduction control related to the sub-contents at to a prescribed timing when the first contents are reproduced is prepared in advance for the first contents. The sub-contents reproducing apparatus includes: a storing unit for obtaining and storing the sub-contents simultaneously with or before distribution of the corresponding sub-contents control information; a first obtaining unit for obtaining, when the first contents are reproduced, the sub-contents control information prepared in advance for the first contents; and a sub-contents control unit responsive to the first obtaining unit obtaining the sub-contents control information, for performing reproduction control corresponding to the obtained sub-contents control information on the sub-contents stored in the sub-contents storing unit.

The storing unit of the sub-contents reproducing apparatus obtains the sub-contents related to the first contents simultaneously with or before distribution of the corresponding sub-contents control information and stores the same. When the first contents are reproduced, the sub-contents control information associated with the prescribed timing is obtained by the first obtaining unit. When the first obtaining unit obtains the sub-contents control information, the sub-contents control unit performs reproduction control related to the sub-contents control information, on the sub-contents stored in the storing unit. The reproduction control is performed on the sub-contents, which are related to, but separate from the first contents, at a timing of application of the sub-contents control information and in accordance with the sub-contents control information. The process defined by the provider of the sub-contents control information for the sub-contents can be realized at a timing defined by the provider of the sub-contents control information, rather than an arbitrary operation by a user of the sub-contents reproducing apparatus. The timing is determined by the sub-contents control information, and therefore, it is unlikely that unfair treatment occurs among users. Further, sub-contents and sub-contents control information can be combined freely. Therefore, execution of sub-contents can be controlled in versatile manner. As a result, a sub-contents reproducing apparatus can be provided, which can execute some process in accordance with the sub-contents to be provided to the user, at a highly reliable timing while preventing unfair treatment among users.

Preferably, the first obtaining unit includes a receiving unit for receiving broadcast and separating the sub-contents control information from the received broadcast.

The sub-contents control information is received from the broadcast. The broadcast is on real time and covers a wide area. To sub-contents reproducing apparatuses existing in such a wide area, the process defined by the service provider can be performed simultaneously, on the sub-contents at a timing defined by the service provider. As a result, a sub-contents reproducing apparatus can be provided, which can execute some process in accordance with the sub-contents to be provided to the user, at a highly reliable timing while preventing unfair treatment among users, in a wide scope.

More preferably, the sub-contents may include one or a plurality of sub-contents data items. The one or a plurality of sub-contents data items each include a piece of process specifying information for specifying a process on the sub-contents data item and a piece of trigger specifying information for specifying of the sub-contents control information acting as a trigger for executing the process, associated with each other. The sub-contents control unit includes a determining unit for determining whether the obtained sub-contents control information matches any of the pieces of trigger specifying information included in any of the one or a plurality of sub-contents data items, and a process executing unit responsive to a determination by the determining unit that the received sub-contents control information matches any of the pieces of trigger specifying information, for executing a process specified by the piece of process specifying information corresponding to the trigger specifying information on the sub-contents data item including the piece of process specifying information.

When any of the pieces of trigger specifying information included in any of the sub-contents data items matches the obtained piece of sub-contents control information, the process specified by the process specifying information corresponding to the piece of trigger specifying information is executed on the sub-contents data. By preparing and distributing such sub-contents having such structure in advance, it becomes possible for the service provider to control the sub-contents reproducing apparatus such that among various intended processes, a desired process can be executed at a desired timing on a desired sub-contents data item. As a result, a sub-contents reproducing apparatus can be provided, which can provide the service intended by the service provider at a timing matching the timing intended by the service provider with high reliability while preventing unfair treatment among users, to a plurality of users of the sub-contents reproducing apparatuses.

More preferably, the determining unit includes an apparatus for determining whether the sub-contents control information obtained by the first obtaining unit matches a prescribed data string specified by any of the pieces of trigger specifying information or not.

Dependent on whether the prescribed data sequence specified by the trigger specifying information and the sub-contents control information match or not, determination is made. Therefore, a sub-contents reproducing apparatus can be provided, which can provide the service intended by the service provider at a timing matching with high reliability the timing intended by the service provider while preventing unfair treatment among users, by a simple determination process in the sub-contents reproducing apparatus.

The determining unit may include an apparatus for specifying, from the one or a plurality of sub-contents data items, the one having the piece of trigger specifying information matching the sub-contents control information obtained by the first obtaining unit, and the process executing unit may include an apparatus for executing, on each of the sub-contents data items specified by the apparatus for specifying, a process specified by the piece of process specifying information associated with the one of the pieces of trigger specifying information included in the sub-contents data item matching the sub-contents control information.

For each of the sub-contents data items having the piece of trigger specifying information specified by the apparatus for specifying, the process corresponding to the piece of trigger specifying information is executed. Thus, a plurality of processes can be executed by utilizing one piece of trigger specifying information, and hence, a sub-contents reproducing apparatus can be provided, which can provide various and many services intended by the service provider at a timing matching with high reliability the timing intended by the service provider while preventing unfair treatment among users.

Preferably, the process specifying information includes sub-contents activation information designating activation of a corresponding sub-contents data item, and sub-contents termination information designating termination of a corresponding sub-contents data item.

Activation and termination of sub-contents can be controlled from the outside.

More preferably, the process specifying information further includes message transmission information that designates generation of a message including data generated from a corresponding sub-contents data item and transmission of the message to a prescribed transmission destination.

In the sub-contents reproducing apparatus that received the message transmission information, a prescribed message is formed and transmitted to a prescribed destination. Not a one-way process but an interactive process can be realized.

The process specifying information further includes data obtaining information that designates obtaining a document specified by a corresponding sub-contents data item.

The document specified by the sub-contents data item may be modified on real time basis even during provision of the first contents, based on various pieces of information. By applying the data obtaining information to the sub-contents reproducing apparatus at a prescribed timing, the sub-contents reproducing apparatus can operate such that the document is obtained at a timing defined by the service provider. As a result, by way of example, messages and the like transmitted from sub-contents reproducing apparatuses may be collected and a document may be dynamically formed based on the result of collection, whereby various services can be provided reflecting the response from the sub-contents reproducing apparatuses.

More preferably, the process executing unit includes an apparatus for activating, among the sub-contents data items specified by the apparatus for specifying, the one including a piece of trigger specifying information matching the obtained sub-contents activating process, independent from other sub-contents data items, and an apparatus for terminating, among the sub-contents data items specified by the apparatus for specifying, the one including a piece of trigger specifying information matching the obtained sub-contents terminating process and having been activated by the apparatus for activating, independent from other sub-contents data items.

A plurality of sub-contents data items are activated independently, and terminated independently. As a result, in the sub-contents reproducing apparatus, it may be possible that a plurality of sub-contents data items are executed parallel to each other. By preparing sub-contents data in advance assuming parallel execution, it becomes possible to provide one or a plurality of sub-contents data items by itself or in parallel, to the user in various manner along the time axis.

The sub-contents reproducing apparatus may further include a contents reproducing unit for receiving broadcast received by the receiving unit and for reproducing contents of the broadcast.

The broadcast contents and the sub-contents can be reproduced simultaneously by one sub-contents reproducing apparatus. As a result, the user of the sub-contents reproducing apparatus can enjoy services using both the main contents and sub-contents, simply by one sub-contents reproducing apparatus.

According to a second aspect, the present invention provides a contents-related service providing system, including: a contents providing apparatus for providing first contents as a main object; and a contents reproducing apparatus for receiving the first contents provided by the contents providing apparatus and for reproducing the contents. The contents-related service providing system further includes a sub-contents providing apparatus for providing sub-contents related to the first contents; and a sub-contents control information providing apparatus for applying to the contents reproducing apparatus sub-contents control information acting as a trigger for a prescribed process on the sub-contents at a prescribed timing when the first contents are reproduced. The contents reproducing apparatus includes a storing unit for obtaining and storing the sub-contents from the sub-contents providing apparatus simultaneously with or before distribution of the corresponding sub-contents control information, an obtaining unit for obtaining, when the first contents are reproduced, the sub-contents control information corresponding to the first sub-contents from the sub-contents control information providing apparatus, and a sub-contents control unit responsive to the obtaining unit obtaining the sub-contents control information, for performing reproduction control corresponding to the obtained sub-contents control information on the sub-contents stored in the sub-contents storing unit.

The storing unit of the sub-contents reproducing apparatus obtains the sub-contents related to the first contents simultaneously with or before distribution of the corresponding sub-contents control information and stores the same. When the first contents are reproduced, the sub-contents control information associated with the prescribed timing is obtained by the first obtaining unit. When the first obtaining unit obtains the sub-contents control information, the sub-contents control unit performs reproduction control related to the sub-contents control information, on the sub-contents stored in the storing unit. The reproduction control is performed on the sub-contents, which are related to, but separate from, the first contents, at a timing of application of the sub-contents control information and in accordance with the sub-contents control information. The process defined by the provider of the sub-contents control information for the sub-contents can be realized at a timing defined by the provider of the sub-contents control information, rather than an arbitrary operation by a user of the sub-contents reproducing apparatus. The timing is determined by the sub-contents control information, and therefore, it is unlikely that unfair treatment occurs among users. As a result, a contents related service providing system can be provided, which can provide some service in accordance with the sub-contents to be provided to the user, at a highly reliable timing while preventing unfair treatment among users.

According to the sub-contents reproducing apparatus and the contents related service providing system of the present invention, sub-contents related to the first contents are prepared in advance, and the sub-contents control information is provided to the sub-contents reproducing apparatus at a prescribed timing. The sub-contents held by the sub-contents reproducing apparatus are controlled in such a scheme. Therefore, the operation intended by the sub-contents provider can be performed on the sub-contents at a timing intended by the sub-contents provider. As the sub-contents control information controls the sub-contents, ill-timed control of sub-contents, which would be experienced by a user operation, can be avoided, and hence, unfair treatment among the users can be avoided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram representing a schematic configuration of a broadcast-contents-combined service system 40 in accordance with a first embodiment of the present invention.

FIG. 2 is a block diagram representing a schematic configuration of a broadcast contents forming apparatus 60 in accordance with the broadcast-contents-combined service system 40.

FIG. 3 is a block diagram representing a schematic configuration of a sub-contents forming apparatus 62 in accordance with the broadcast-contents-combined service system 40.

FIG. 4 is a block diagram representing a schematic configuration of a broadcast contents packing apparatus 70 in accordance with the broadcast-contents-combined service system 40.

FIG. 5 is a block diagram representing a schematic configuration of a broadcast contents reproducing apparatus 50 in a portable terminal 48 in the broadcast-contents-combined service system 40.

FIG. 6 is a block diagram representing a schematic configuration of a sub-contents reproducing apparatus 52 in a portable terminal 48 in the broadcast-contents-combined service system 40.

FIG. 7 is a block diagram representing a schematic configuration of a broadcast-contents-combined service providing apparatus 64 in the broadcast-contents-combined service system 40.

FIG. 8 shows data structure of sub-contents used in the broadcast-contents-combined service system 40.

FIG. 9 shows a former half of an XML document related to exemplary sub-contents.

FIG. 10 shows a latter half of the XML document related to exemplary sub-contents.

FIG. 11 shows a main image as an exemplary display based on the broadcast contents.

FIG. 12 shows a sub-contents output image as an exemplary display based on the broadcast contents.

FIG. 13 shows the AV data configuration included in the broadcast contents and details of broadcast contents sub-data.

FIG. 14 shows the AV data included in the broadcast contents and a timing chart indicating the timing of sub-contents image output.

FIG. 15 is a process sequence diagram showing processes performed in various apparatuses included in the broadcast-contents-combined service system 40 and data from among the apparatuses.

FIG. 16 is a flowchart representing control structure of a computer program realizing the broadcast contents reproducing apparatus 50.

FIG. 17 is a flowchart representing control structure of a computer program realizing the sub-contents reproducing apparatus 52.

FIG. 18 schematically shows an example of an HTML document included in the sub-contents.

FIG. 19 shows a message data structure and an exemplary message used when a transmission process is performed in accordance with the sub-contents.

FIG. 20 is a block diagram representing a schematic configuration of a broadcast-contents-combined service system 600 in accordance with a second embodiment of the present invention.

FIG. 21 is a block diagram representing a schematic configuration of a sub-contents forming apparatus 612 in the broadcast-contents-combined service system 600.

FIG. 22 shows data structure of sub-contents used in the broadcast-contents-combined service system 600.

FIG. 23 shows, in an XML format, exemplary sub-contents included in the broadcast contents.

FIG. 24 shows the AV data configuration included in the broadcast contents and details of broadcast contents sub-data.

FIG. 25 shows an exemplary display image based on the broadcast contents.

FIG. 26 shows the AV data included in the broadcast contents and a timing chart indicating the timing of sub-contents image output.

FIG. 27 is a process sequence diagram showing processes performed in various apparatuses included in the broadcast-contents-combined service system 600 and data from among the apparatuses.

FIG. 28 is a flowchart representing a control structure of a computer program realizing the sub-contents reproducing apparatus 630 in a portable terminal 622.

FIG. 29 shows an exemplary HTML document included in the sub-contents.

### DESCRIPTION OF THE PREFERRED EMBODIMENTS

In the following, broadcast-contents-combined service system in accordance with first and second embodiments of the present invention will be described with reference to the figures. In the figures, the same components are denoted by the same reference characters. The names and functions are also the same. Therefore, detailed description thereof will not be repeated. In the description of embodiments, the following terms have the following meanings.

“Broadcast contents” means AV data for broadcast and broadcast contents sub-data, which will be described later, packed together. The broadcast contents represent streaming data that may be reproduced on real-time when received.

“Broadcast contents sub-data” generally refers to sub-contents control information and message use information, which will be described later.

“Sub-contents” refer to information necessary to provide a prescribed service on a terminal, in combination with the contents. The sub-contents include data (layout designating data) that designates a display layout when service-related information is to be displayed on a terminal, data representing message structure and destination of a message to be transmitted from the terminal to a prescribed destination, and information for interpreting sub-contents control information received together with the broadcast contents and executing activation, reproduction and termination of sub-contents. The sub-contents are distributed through broadcast or network in the following embodiments. The sub-contents, however, may be distributed through other medium. Further, the sub-contents include a plurality of sub-contents data items that can be activated and terminated independent from each other. The sub-contents data items may be nested.

“Sub-contents control information” refers to information distributed to a terminal at a prescribed timing together with the broadcast contents, for controlling activation, reproduction, termination and the like of sub-contents.

“message use information” refers to data used when sub-contents form a message. The message use information is distributed to a portable terminal in association with the broadcast contents.

“Sub-contents control determining information” refers to information as a part of sub-contents that is used for condition determination when the received sub-contents control information is interpreted and activation, reproduction or termination of sub-contents is executed.

### First Embodiment

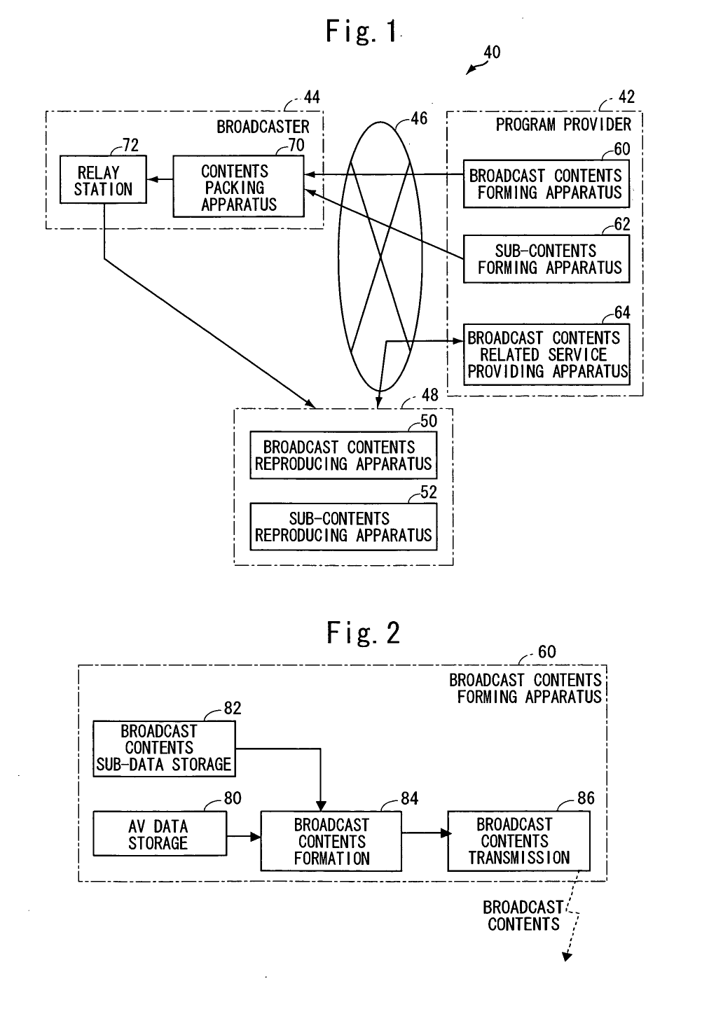

The broadcast-contents-combined service system in accordance with the first embodiment of the present invention will be described with reference to FIGS. 1 to 19.

<Configuration>

FIG. 1 shows a schematic configuration of a broadcast-contents-combined service system 40 in accordance with a first embodiment of the present invention. The embodiment shown in FIG. 1 is directed to an exemplary service wherein the broadcast contents are a quiz program and wherein a viewer provides his/her answer to the quiz through a portable terminal (for example, a portable telephone). In system 40 in accordance with the present system, it is assumed that the sub-contents related to the broadcast contents are obtained by the portable terminal before or simultaneously with the broadcast, through broadcast or a network.

In the quiz program, when a question image is displayed in the broadcast program, an answer image to the question defined by sub-contents appears together with the question image, in a prescribed layout. The answer image includes a plurality of possible answers. When the user selects any of the answers, the result is temporarily stored in the terminal. At a timing defined by the sub-contents control information, a piece of information representing the answer is transmitted to the server of a service operator of the quiz program, through a network. On the server, answers from a plurality of terminals are collected, new contents are formed therefrom, and distributed to the terminals through the network. The terminal receives and stores the contents. At a timing when the terminal receives a different piece of sub-contents control information, an image based on the broadcast contents and the sub-contents is displayed in a layout designated in advance by the sub-contents.

Referring to FIG. 1, broadcast-contents-combined service system 40 includes: a program producer 42 that forms broadcast contents (program); a broadcaster 44 that receives the broadcast contents produced by program producer 42 through a network 46 and broadcasts the same at a designated time; and one or a plurality of portable terminals 48 for reproducing the broadcast contents and the sub-contents broadcast by the broadcaster 44. Portable terminal 48 is capable of communication with facilities of program producer 42 through the network 46.

Program producer 42 has: broadcast contents forming apparatus 60 for forming contents to be broadcast (broadcast contents), and sub-contents forming apparatus 62 for forming sub-contents related to the broadcast contents. The broadcast contents and sub-contents are packed as will be described later, and form the contents that are broadcast by the broadcaster 44. Program producer 42 further has a broadcast-contents-combined service providing apparatus 64 for providing a service combined with the broadcast contents to a user of terminal 48. Apparatuses 60, 62 and 64 are all capable of communication to other apparatuses, through network 46.

Broadcaster 44 has a contents packing apparatus 70 capable of communicating with apparatuses 60 and 62 of the program producer 42, for packing the broadcast contents received from broadcast contents forming apparatus 60 with the sub-contents received from sub-contents forming apparatus 62 for broadcast, and a relay station 72 for broadcasting, in digital manner, the contents packed by contents packing apparatus 70.

Portable terminal 48 includes: a broadcast contents reproducing apparatus 50 for separating broadcast contents from other data of the contents broadcast from the relay station 72, reproducing the broadcast contents and outputting data other than the broadcast contents; and a sub-contents reproducing apparatus 52 for holding the sub-contents applied from broadcast contents reproducing apparatus 50 and executing a process in accordance with the sub-contents in response to sub-contents control information applied from broadcast contents reproducing apparatus 50, thereby to reproduce the sub-contents.

Referring to FIG. 2, broadcast contents forming apparatus 60 includes: an AV data storing unit 80 for storing AV data for the broadcast program; a broadcast contents sub-data storing unit 82 for storing broadcast contents sub-data designed and prepared in advance in accordance with the contents of the AV data and of the sub-contents; a broadcast contents forming unit 84 packing the AV data stored in AV data storing unit 80 with the broadcast contents sub-data stored in broadcast contents sub-data storing unit 82 to form broadcast contents; and a broadcast contents transmitting unit 86 for transmitting the broadcast contents formed by broadcast contents forming unit 84 to contents packing apparatus 80 through the network 46. AV data storing unit 80 and broadcast contents sub-data storing unit 82 may be implemented with a storage apparatus such as a HDD (hard disk drive). In the present embodiment, broadcast contents forming unit 84 is implemented with a storage apparatus such as a RAM or a flash memory, a CPU and a program stored in a storage apparatus, and its function is attained when the program is executed by the CPU.

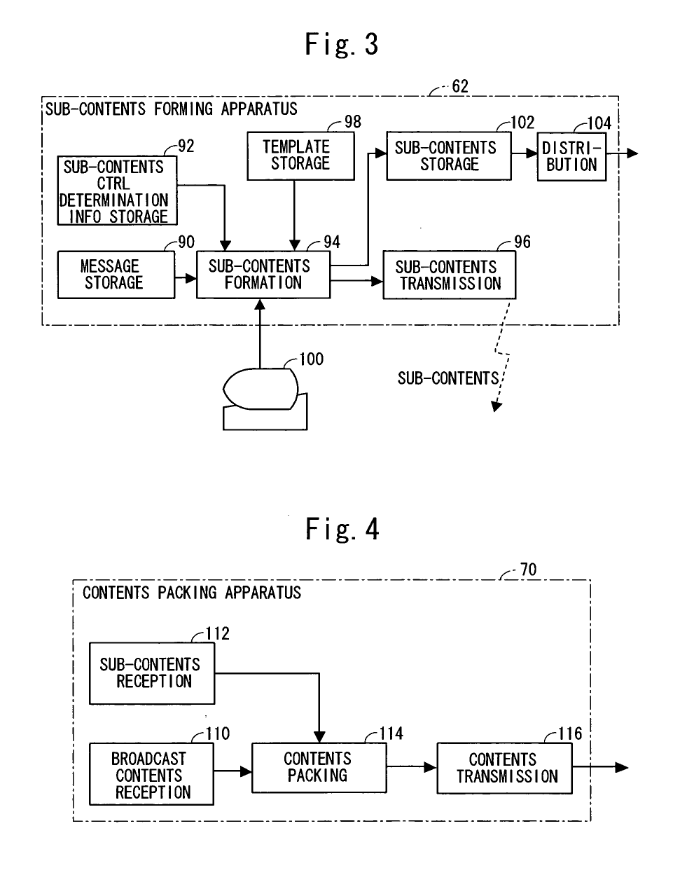

Referring to FIG. 3, sub-contents forming apparatus 62 includes: a message storing unit 90 for storing a message formed in advance by a service provider to be combined with the broadcast; a sub-contents control determination information storing unit 92 for storing sub-contents control determination information specifying which process is to be executed upon reception of which piece of contents control information; a template storing unit 98 for storing a template as a prototype of sub-contents; an operating unit 100 for receiving an operation instruction from a user; a sub-contents forming unit 94 for forming sub-contents by combining appropriate piece of sub-contents control determination information stored in sub-contents control determination information storing unit 92 with the message stored in message storing unit 90, using a template stored in template storing unit 98, in accordance with the instruction received from the operator through operating unit 100; and sub-contents transmitting unit 96 for transmitting the sub-contents formed by sub-contents forming unit 94 to contents packing apparatus 70 through the network 46.

Message storing unit 90 and sub-contents control determination information storing unit 92 are formed with a storage apparatus such as an HDD. Sub-contents forming unit 94 is realized by a program stored in a storage apparatus such as a RAM or a flash memory executed by a CPU.

Sub-contents forming apparatus 62 further includes: a sub-contents storing unit 102 for storing the sub-contents formed by sub-contents forming unit 94; and a sub-contents distributing unit 104 connected to the network 46 and upon reception of a sub-contents transmission request through the network 46, for reading and returning the designated sub-contents from sub-contents storing unit 102, or transmitting the sub-contents to a portable terminal 48 registered beforehand when a prescribed time comes.

In the present embodiment, the sub-contents are formed in an XML (eXtensible Markup Language) format.

Referring to FIG. 4, contents packing apparatus 70 includes; a broadcast contents receiving unit 110 for receiving the broadcast contents from broadcast contents forming apparatus 60; a sub-contents receiving unit 112 for receiving the sub-contents from sub-contents forming unit 62; a contents packing unit 114 for packing the broadcast contents and the sub-contents received by broadcast contents receiving unit 110 and sub-contents receiving unit 112 for forming contents to be reproduced as video images and sounds of a TV program and data associated with the TV program; and a contents transmitting unit 116 for transmitting the TV program contents formed by contents packing unit 114 to the broadcaster 44 through the network 46. Broadcaster 44 broadcasts the received TV program contents at a prescribed time of broadcast, from relay station 72.

Packing at broadcast contents packing unit 114 means that the sub-contents are not included in the data of broadcast contents but are turned to a format that can be received by portable terminal 48. Therefore, though the broadcast contents and sub-contents are both distributed through the relay station, the data are transmitted separately.

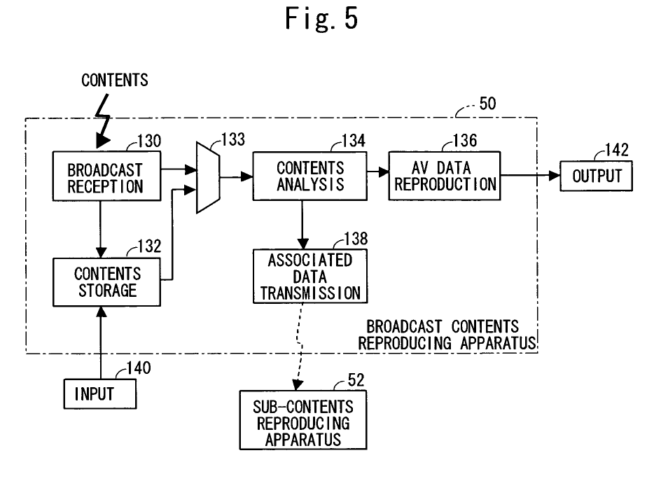

Referring to FIG. 5, broadcast contents reproducing apparatus 50 shown in FIG. 1 includes: a broadcast receiving unit 130 for receiving the TV program contents broadcast from relay station 72; an input unit 140 for receiving a user operation; a contents storing unit 132 for storing the contents received by broadcast receiving unit 130 and outputting contents designated by the user in accordance with an instruction from input unit 140; a selecting unit 133 having a first input for receiving an output from broadcast receiving unit 130 and a second input for receiving an output from contents storing unit 132, for selectively outputting a signal at the first input or at the second input in accordance with settings; a contents analyzing unit 134 for analyzing the contents output from selecting unit 133 and separately outputting the broadcast contents and associated data other than the broadcast contents (broadcast contents sub-data or sub contents, same in the following); an AV data reproducing unit 136 for reproducing the broadcast contents output from contents analyzing unit 1334 and outputting vide and audio signals; an output unit 142 implemented with a liquid crystal display and a speaker, for outputting the video and audio signals from AV data reproducing unit 136; and associated data transmitting unit 138 for transmitting the broadcast contents sub-data and sub-contents output from contents analyzing unit 134 to sub-contents reproducing apparatus 52. In the present embodiment, associated data transmitting unit 138 is directly connected to sub-contents reproducing apparatus 52.

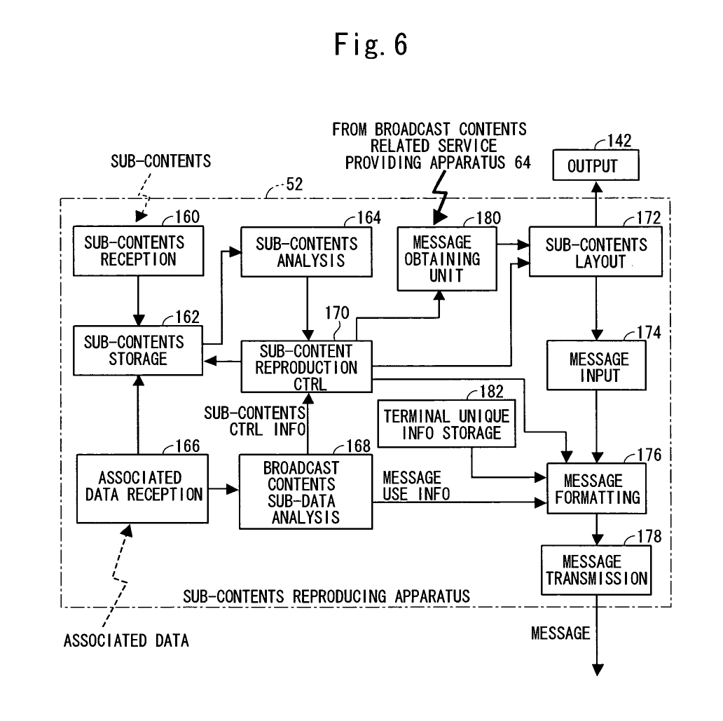

Referring to FIG. 6, sub-contents reproducing apparatus 52 includes: a sub-contents receiving unit 150 connected to the network 46 for receiving the sub-contents transmitted from sub-contents forming apparatus through the network 46; an associated data receiving unit 166 for receiving the associated data transmitted from associated data transmitting unit 138 shown in FIG. 5 and separating the associated data into the broadcast contents sub-data and sub-contents; a sub-contents storing unit 162 for storing the sub-contents received by sub-contents receiving unit 160 and the sub-contents received by associated data receiving unit 166. The sub-contents receiving unit 160 is used when the sub-contents are received through the network from a sub-contents forming apparatus or the like, and in the present embodiment, it is assumed that the sub-contents reproducing apparatus 52 uses only the sub-contents transmitted via the broadcast wave. Therefore, in the sub-contents reproducing apparatus 52 in accordance with the present embodiment, sub-contents receiving unit 160 is not used.

The sub-contents reproducing apparatus further includes: a broadcast contents sub-data analyzing unit 168 for analyzing the broadcast contents sub-data output from associated data receiving unit 166 and for identifying, separating and outputting, from the broadcast contents sub-data, the sub-contents control information and message use information; a sub-contents analyzing unit 164 for analyzing the sub-contents stored in sub-contents storing unit 162 and for identifying and outputting, from the sub-contents, the layout information, message transmission destination, message structure and sub-contents control determination information; and a sub-contents reproduction control unit 170 for determining in which manner the sub-contents should be reproduced, and outputting layout information necessary for reproduction and sub-contents to be displayed, based on the sub-contents control information output from broadcast contents sub-data analyzing unit 168 and on sub-contents control determination information output from sub-contents analyzing unit 164. Sub-contents reproduction control unit 170 further has a function of separating and outputting the message use information output from sub-contents analyzing unit 164.

Sub-contents reproducing apparatus 52 further includes: a message obtaining unit 180 for performing a process of obtaining data designated by sub-contents reproduction control unit 170 from broadcast-contents-combined service providing apparatus 64, in accordance with an instruction from sub-contents reproduction control unit 170; and a sub-contents layout unit 172 for determining and applying to output unit 142 a display layout on a display unit 142, based on the data obtained by message obtaining unit 180, the layout information and the sub-contents output from sub-contents reproduction control unit 170. The sub-contents laid-out by sub-contents layout unit 172 may include an image prompting the user to input a message. This image is, for example, an answer image for inputting an answer to a quiz.

Sub-contents reproducing apparatus 52 further includes: a terminal unique information storing unit 182 for storing information unique to sub-contents reproducing apparatus 52; a message input unit 174 for receiving data input by a user using the message input image output by sub-contents layout unit 172; a message formatting unit 176 for forming a message to be transmitted to the destination designated by the sub-contents in a prescribed format and at a timing designated by sub-contents reproduction control unit 170, based on the data input by the user output from message input unit 174, message use information output from broadcast contents sub-data analyzing unit 168 and terminal unique information stored in terminal unique information storing unit 182; and a message transmitting unit 178 for transmitting the message formed by formatting unit 176 through the network 46.

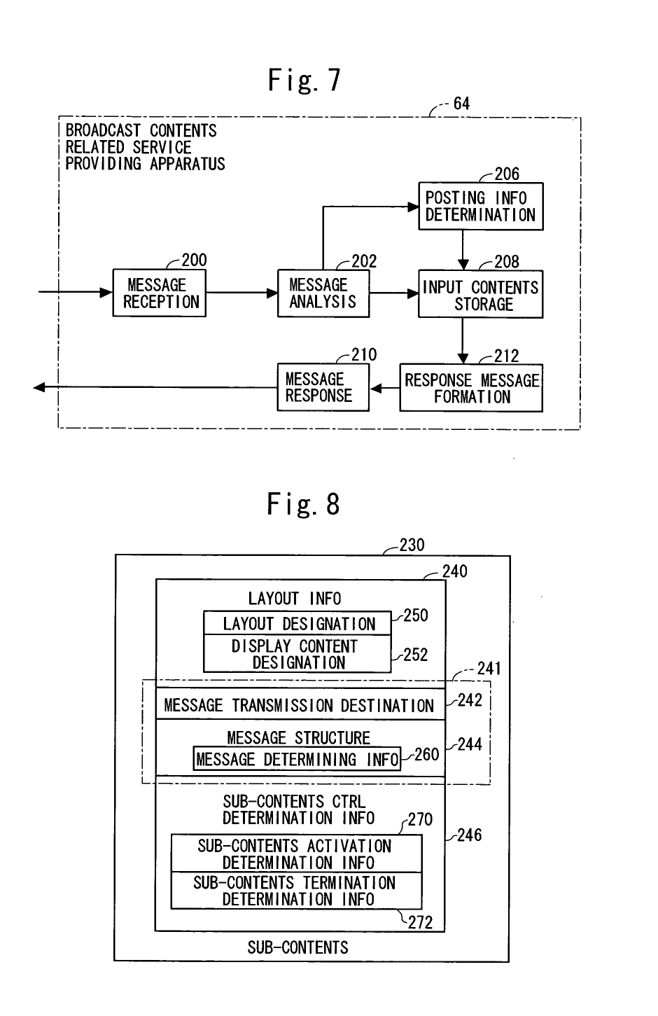

Referring to FIG. 7, broadcast-contents-combined service providing apparatus 64 possessed by program producer 42 shown in FIG. 1 includes: a message receiving unit 200 for receiving the message from the terminal through network 46; a message analyzing unit 202 for analyzing the message received by message receiving unit 200, for separately outputting, from the contents of the message, message determining information indicating to which service the message corresponds, and elapsed time information of the answer to the quiz and answer information included in the message; a posting information determining unit 206 receiving the message determining information output from message analyzing unit 202 for determining to which service the message received by message receiving unit 200 corresponds; and an input contents storing unit 208 for storing the elapsed time information and the answer information output from message analyzing unit 206 in correspondence to information specifying the service determined by posting information determining unit 206. The correspondence between the message and the service is determined by the posting information determining unit 206, since there may possibly be a plurality of services for any one of the broadcast contents.

By way of example, in the quiz program described in the present embodiment, the first question and the second question may be considered as different services. Contents posted for the questions, however, commonly include answers to the questions and the elapsed time information indicating the time from when the question is brought up until an answer is selected. When the received message includes information for distinguishing one question from another, the user can answer to a plurality of questions (to enjoy a plurality of services) using the same sub-contents and the same message format. As the posted contents and the corresponding services are stored in relation to each other in input contents storing unit 208, the program producer can easily tell which postings correspond to which question of which broadcast program, and can easily count answers question by question.

The broadcast-contents-combined service providing apparatus 64 further includes: a response message forming unit 212 for forming a message allowing sub-contents reproducing apparatus 52 to display information changing on real-time basis during a service, based on the elapsed time information and the answer information for each service stored in input contents storing unit 208; and a message responding unit 210 for returning the message formed by responses message forming unit 212 to the transmission source of the message received by message receiving unit 200.

Specifically, the message formed by response message forming unit 212 is as follows. In the present embodiment, in a quiz program service provided by the program producer, a message that dynamically changes during the service is formed, such as the result of counting of quiz posted by viewers through portable terminals 48 (including the ratio of correct answer) or ranking of answers by the viewers. Input contents storing unit 308 includes a storage apparatus such as an HDD. Response message forming unit 212 includes a program formed in a prescribed format.

FIG. 8 shows a configuration of sub-contents. Referring to FIG. 8, sub-contents 230 includes: layout information 240 related to display layout of an image including the sub-contents; message information 241 necessary for forming the message that is formed by formatting unit 176; and sub-contents control determination information 246 including conditions for controlling activation and termination of sub-contents.

Layout information 240 includes layout designating information 250 for designating a layout for displaying an image, and display contents designating information 252 for designating the contents to be displayed. Layout information 240 is interpreted by sub-contents layout unit 273 of sub-contents reproducing apparatus 52 shown in FIG. 6. Output unit 142 reproduces the designated sub-contents in the designated layout, in accordance with the layout information 240.

Message information 241 includes templates of a plurality of messages for different types of questions. Each template includes message destination information 242 indicating a transmission destination of the message, and message structure information 244 for indicating structure of the message to be formed.

Message structure information 244 includes message determining information 260 specifying correspondence between the message to be transmitted and the service related to the message. Posting information determining unit 206 shown in FIG. 7 determines, based on the message determining information 260, to which service the received message corresponds.

Sub-contents control determination information 246 includes: sub-contents activation determination information 270 as a reference for determining whether the sub-contents should be activated or not, and sub-contents termination determination information 272 as a reference for determining whether the sub-contents should be terminated or not. Sub-contents control determination information 246 is the object of analysis by sub-contents analyzing unit 164 in sub-contents reproducing apparatus 52. In this manner, determination of one of or both of activation and termination is possible, and activation or termination is done accordingly. A series of descriptions in the sub-contents is referred to as “sub-contents data item.” Determination of activation and termination can be done for each of the items, independent from each other.

The order of describing pieces of information in sub-contents 230 may be fixed in accordance with a predetermined format, or may be freely defined in the form of tags and corresponding contents as in the XML format. In the present embodiment, it is assumed that sub-contents are in the XML format.

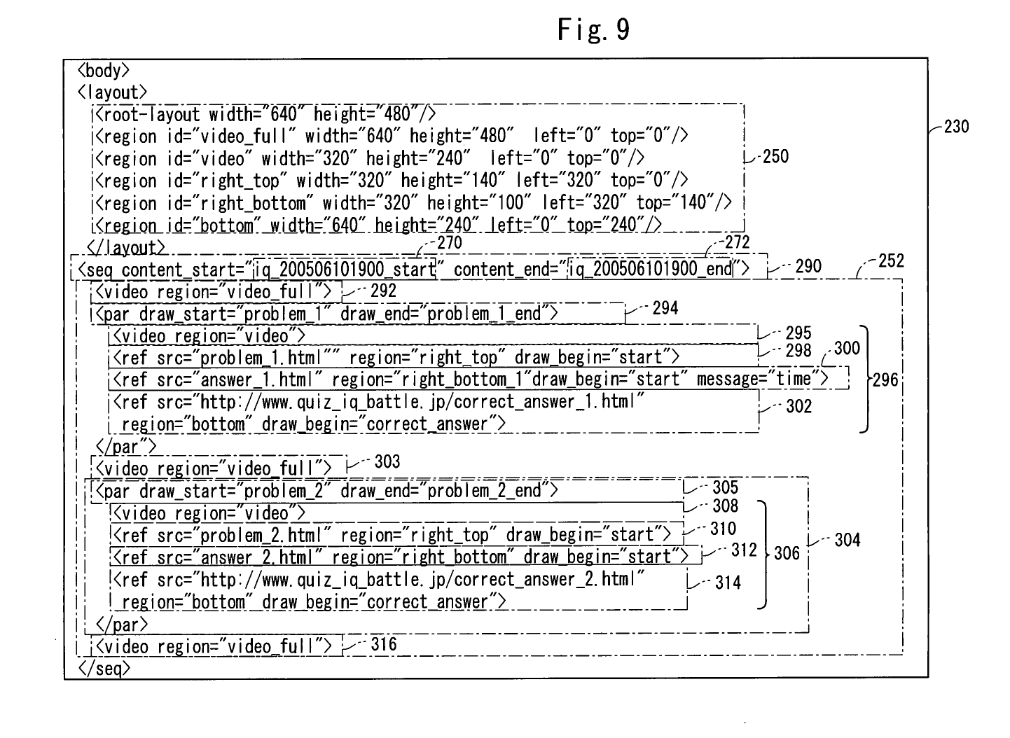

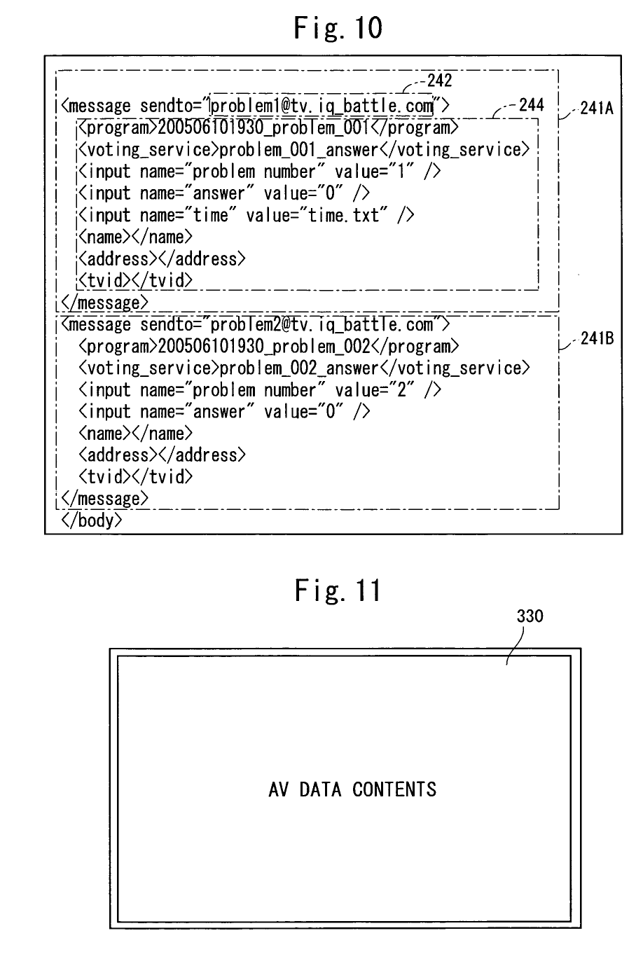

FIGS. 9 and 10 show specific examples of sub-contents 230 in the XML format. FIG. 9 shows the former half and FIG. 10 shows the latter half of sub-contents 230, respectively.

Referring to FIGS. 9 and 10, sub-contents 230 includes layout information 250, sub-contents activation determination information 290, display contents designating information 252, first message destination information 242, first message structure information 244, second message destination information 246 and second message structure information 248.

In the present embodiment, layout information 250 is described following the tag <layout>. Assuming that the image size is 640 pixels wide×480 pixels height, the layout information designates a full region (id=video_full), a region of 320 pixels wide×240 pixels height (id=video), an upper right region of 320 pixels wide×140 pixels height (id=right_top), a lower right region of 320 pixels wide×100 pixels height (id=right_bottom) and a lower region of 320 pixels wide×100 pixels height (id=bottom).

Referring to FIG. 9, sub-contents activation determination information 290 starting with a “seq” tag includes pieces of sub-contents activation determination information 270 and 272, which indicate that a series of displays should be given in the order of description in accordance with the display contents designating information 252 described between the “seq” tag and “seq” end tag </seq>, and which are used for determining upon reception of which sub-contents control information the series of displays are to be started and upon reception of which sub-contents control information the displays should be terminated.

Sub-contents activation determination information 270 indicates that the series of displays specified by display contents designating information 252 should be started when sub-contents control information “iq_{—}200506101900_start” is received. Sub-contents termination determination information 272 indicates that the series of displays should be terminated when sub-contents control information “iq_{—}200506101900_end” is received.

Display contents designating information 252 includes: display contents designating information 292 for the main image indicating that a TV image should be displayed on the entire output image at the beginning; display contents designating information 294 for a quiz image following the display contents designating information 292 for the main image, designating that when a prescribed piece of sub-contents control information is received, a plurality of images for the sub-contents (in the present embodiment, image of the first question of the quiz) are to be displayed in parallel; display contents designating information 303 for the main image indicating that a TV image should be displayed on the entire output image after the end of display in accordance with display contents designating information 294 for the quiz image; display contents designating information 304 for a quiz image designating that, following the display of the main image, when a prescribed piece of sub-contents control information is received, images for the second question of the quiz are to be displayed in parallel; and display contents designating information 316 for the final main image.

In the example shown in FIG. 9, the term that follows a keyword “region=” (region attribute) indicates the region where the corresponding image should be displayed. By way of example, when display contents designating information 292 for the main image is “region=video_full”, it means that the designated contents should be displayed using the full image screen (of, for example, 640 pixels×480 pixels). In the present embodiment, regions that may be designated by “region=” includes “right_top”, “right_bottom_{—}1”, “bottom”, “right_bottom” and the like, which are defined beforehand. The names of these regions should preferably indicate the specific locations of the actual regions.

The “video” tag of display contents designating information 292 for the main image indicates that the AV data of broadcast contents should be displayed on this image.

In the example shown in FIG. 9, display contents designating information 294 for a quiz image is represented by the tag <par>, and indicates that when the sub-contents control information “problem_{—}1” is received, the display of the quiz image should be started, and the display of the quiz image should be terminated when the sub-contents control information “problem_{—}1_end” is received.

The contents of display and sequence of the quiz image are indicated by image sequence information 296 described between the “par” tag and a “par end” tag (/<par>). When the display contents are designated by the “par” tag, start and end of each image are designated by the sub-contents control information. When a plurality of images are designated to be displayed, the images are displayed simultaneously and in parallel on the screen.

In the example shown in FIG. 9, image sequence information 296 includes: sub-contents activation determination information 295 for the main image; sub-contents activation determination information 298 corresponding to an image displaying a first question of the quiz; sub-contents activation determination information 300 corresponding to an answer image displaying possible answer to the first question; and sub-contents activation determination information 302 corresponding to an image displaying result of counting of the answers to the fist question. These pieces of sub-contents activation determination information each include: a description (draw_begin=) designating sub-contents control information designating the timing of starting display, that is, information specifying the sub-contents control information that triggers activation of the sub-contents; a description (src=) designating the sub-contents as the object of display; and a description (region=) designating the display region. For the sub-contents that receive an input such as the sub-contents activation determination information 300 corresponding to the answer image, a description (message=) specifying a message to be transmitted upon reception of an input is additionally included. After “=” of each description, the corresponding sub-contents control information, name of the sub-contents or name of a variable is described.

By way of example, turn to sub-contents activation determination information. When the sub-contents control information “start” is received, the display of sub-contents “problem_{—}1.html” that are locally stored starts on the region “right_top” of the image. Operations are similar in other examples. As for the keywords and the like of XML format will not be described in detail in the following, except for those which are particularly important.

The display contents designating information 304 for a quiz image includes: display contents designating information 305 of the quiz image, and image sequence information 306 for displaying a series of sub-contents in accordance with the display contents designating information 305. The image sequence information 306 for sub-contents display includes, similar to image sequence information 296, sub-contents activation determination information 308 for the main image, sub-contents activation determination information 312 for the second question of the quiz, and sub-contents activation determination information 314 for the image displaying the result of counting of the answers to the second question.

Referring to FIG. 10, sub-contents 230 further includes, as templates of the message structure, first message information 241A and second message information 241B. The first message information 241A and the second message information 241B have the same structure. Therefore, only the first message information 241A will be described in the following.

The first message information 241A includes a <message> tag line describing message destination information 242 (electronic mail address of broadcast-contents-combined service providing apparatus 64), and message structure information 244 indicating the structure of the message to be transmitted, described after the <message> tag line. In the present embodiment, message structure information 244 is described basically in accordance with the same rule as HTML, and includes template specifying information indicated by the <program> tag, service specifying information indicated by <voting_service> tag, three <input> tags representing question number, answer information and elapsed time to the answer, and <name> tag, <address> tag and <tvid> tag for describing information unique to the sub-contents reproducing apparatus 52.

In <program> attribute and in <voting_service> attribute, values are set beforehand in the present embodiment. Further, in the input tag having the name “problem number” (“name” attribute), a question number of “1” is placed in advance. This is because the template is determined to be used for the answer to the first question. In the “value” attribute of the input tag having the “name” attribute “answer”, a value “0” is placed in advance. That the value is “0” means that no answer has been selected by the user. When the user selects an answer, the selected value is placed here.

Message information 241B differs from message information 241A in that the last one of the <input> tags is not included.

Necessary values of the tags are inserted when the message is formed.

In the <program> tag, information specifying a TV program is placed, and in <voting_service> tag, information specifying the question number of the quiz is placed. The information specifying the program and the information specifying the question number of the quiz correspond to the message determination information 260 determined by posting information determining unit 206 of broadcast-contents-combined service providing apparatus 64.

FIG. 11 shows an example of the main image. The main image 330 corresponds to the display contents designating information 292 shown in FIG. 9. On main image 330, AV data included in the broadcast contents are displayed. The image is designated by <region=full>, and displayed upon reception of sub-contents control information “iq_{—}200506101900”.

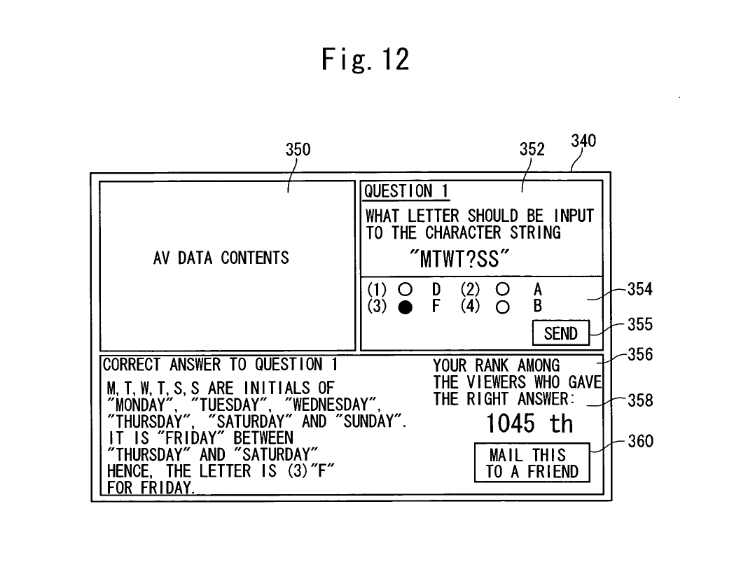

FIG. 12 shows an example of division of display regions for the quiz image indicated by image sequence information 296. Referring to FIG. 12, the quiz image 340 is divided into regions 350, 352, 354 and 356. These regions are designated by “region” attributes “left_top”, “right_top_{—}1”, “right_top_{—}2” and “bottom”, respectively.

In the present embodiment, in region 354, buttons corresponding to possible answers are displayed, together with a button 355 designating transmission of the answer. In region 356, a correct answer of the first question, ranking 358 of the user of sub-contents reproducing apparatus 52 obtained by counting the answers, and a button 360 for mailing a friend about this service are displayed.

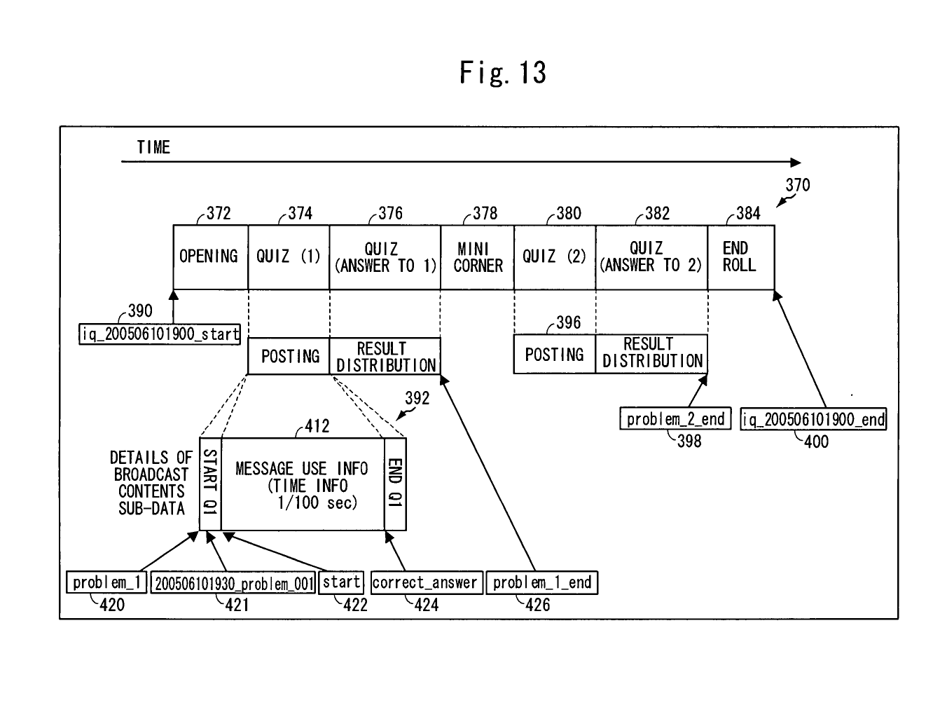

FIG. 13 shows an exemplary configuration of the broadcast contents and broadcast contents sub-data. Referring to FIG. 13, broadcast contents 370 in accordance with the present embodiment have contents of a quiz program arranged in time sequence. Broadcast contents 370 includes: an opening portion 372 of the quiz program; a quiz giving portion 374 putting the first question, following the opening portion 372; an answer displaying portion 376 displaying a correct answer to the first question; a portion 378 referred to as a “mini corner” (hereinafter referred to as the “mini corner portion”) 378 displayed after the end of answer displaying portion 376; a quiz giving portion 380 putting the second question; an answer displaying portion 382 displaying a correct answer to the second question; and an end-roll portion 384 of the program.

Broadcast contents 370 further includes: sub-contents control information 390 broadcast packed with the AV data at the beginning of opening portion 372; sub-contents control information 392 defining a posting region that matches the portion 374 of the first question of the quiz, and broadcast packed with the AV data from the start to the end of that portion; sub-contents control information 426 distributed at the end of the answer displaying portion 376, for defining a period from the end of the posting region to the end of answer displaying portion 376; sub-contents control information 396 defining the posting region corresponding to the portion 380 of the second question of the quiz; sub-contents control information 398 broadcast at the end of answer displaying portion 382 for defining a result distribution region that matches the answer display portion 382 for the second question; and sub-contents control information broadcast at the end of broadcast contents 370.

Sub-contents control information 392 includes: sub-contents control information 420 transmitted to designate start of display of the quiz image at the start of quiz giving portion 374 putting the first question; sub-contents control information 421 designating a template of the message used for the processing of the first question, immediately following the sub-contents control information 420; sub-contents control information 422 transmitted to start display of the quiz image of the first question; message use information 412 broadcast continuously from the start of display to the end of display of the question, following sub-contents control information 422; and sub-contents control information 424 transmitted to designate the end of display of the first question.

In the present embodiment, message use information 412 includes a number of pieces of sub-contents control information, each including time information measured by the unit of 1/100 second, counted with the start time of the first question being zero. By the message use information 412 as such, when actually used, sub-contents reproducing apparatus 52 obtains the elapsed time information from the sub-contents control information at the timing when any of the buttons of possible answers shown in FIG. 12 is pressed. Further, sub-contents reproducing apparatus 52 transmits a message having such structure as represented by message information 241A of FIG. 10 including the obtained elapsed time information, to broadcast-contents-combined service providing apparatus 64 at a timing when the button 355 is pressed.

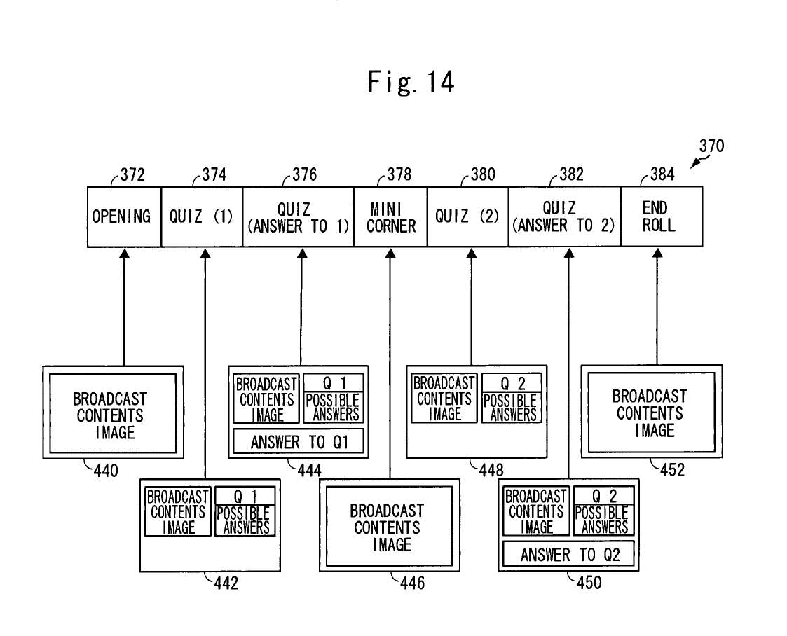

FIG. 14 shows how the image display changes on portable terminal 48 in accordance with broadcast contents 370 shown in FIG. 13.

Referring to FIG. 14, while the opening portion 372 is being reproduced, broadcast contents image 440 is displayed.

Thereafter, when reproduction of quiz giving portion 374 starts, an image 442 corresponding to sub-contents activation appears. Image 442 corresponding to sub-contents activation includes a broadcast contents image, a question image, and an answer selecting image displaying possible answers to the question.

When display of answer displaying portion 376 starts, an answer display image 444 appears. When the answer display portion 376 ends, reproduction of mini corner portion 378 starts, and broadcast contents image 446 is displayed.

Thereafter, when the quiz giving portion 380 putting the second question starts, a question display image 448 is displayed. When reproduction of answer display portion 380 starts, an image 448 including the display of a correct answer to the second question appears, in addition to the displays of broadcasting image, question display image and answer selecting image. When the answer time to the question ends, reproduction of end roll portion 384 starts, and a broadcast contents image 452 is displayed. Then, when the sub-contents control information defining the termination timing of broadcast contents 370 is received, the display of end roll portion 384 ends.

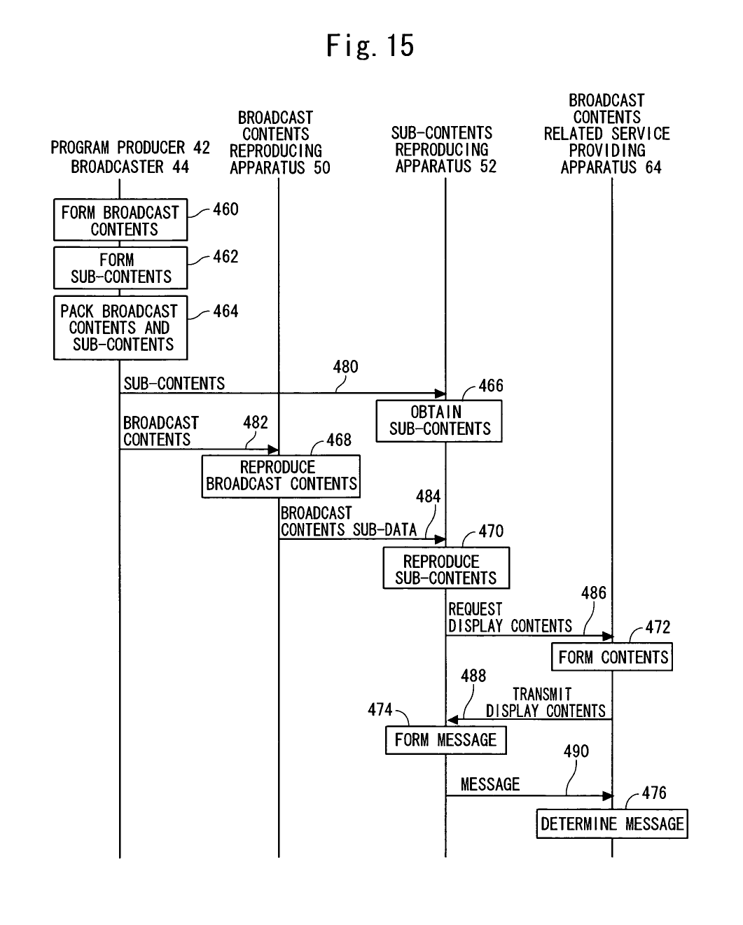

FIG. 15 shows sequences of operations between various apparatuses in accordance with the present embodiment. Referring to FIG. 15, program producer 42 forms broadcast contents and sub-contents related to the program. Sub-contents 480 are transmitted to sub-contents reproducing apparatus 52 through the communication network 46 before the start of broadcast of the program, and obtained by sub-contents reproducing apparatus 52 (step 466). Here, it is assumed that the sub-contents are obtained by sub-contents reproducing apparatus 52 through relay station 72, at the time when the program starts.

When it comes to the broadcast time of the program, broadcaster 44 broadcasts the broadcast contents 482 through relay station 72. The broadcast contents include broadcast contents sub-data associated therewith. Receiving the broadcast, broadcast contents reproducing apparatus 50 reproduces the AV data included in the broadcast contents (step 468).

When broadcast contents 482 includes broadcast contents sub-data, broadcast contents reproducing apparatus 50 separates the sub-contents control information, and transmits it as broadcast contents sub-data 484 to sub-contents reproducing apparatus 52. Receiving the broadcast contents sub-data, sub-contents reproducing apparatus 52 determines whether there is any process to be executed in accordance with the sub-contents control information, based on the sub-contents control information, and if any, executes the corresponding process.

By way of example, if the received sub-contents control information is the sub-contents control information 420 (“problem_{—}1”) shown in FIG. 13, a display in accordance with display contents designating information 294 of the quiz image shown in FIG. 9 starts. If the sub-contents control information is the sub-contents control information 422 (“start”) shown in FIG. 13, the display indicated by sub-contents activation determination information 298 and 300 shown in FIG. 9 starts.

Further, if a process designating display of information indicated by a URL (Uniform Resource Locator) on the web is activated as represented by sub-contents activation determination information 302 shown in FIG. 9, a display data request 486 indicated by the URL is transmitted to broadcast-contents-combined service providing apparatus 64, as shown in FIG. 15. The broadcast-contents-combined service providing apparatus 64 prepares the contents that meet the request, and transmits it to sub-contents reproducing apparatus 52 (step 488). Though the data represented by sub-contents activation determination information 300 corresponding to the answer image of FIG. 9 are local data, the process described here is executed when an external URL is designated by the “src” attribute.

When sub-contents for forming a message are activated, sub-contents reproducing apparatus 52 forms a message (step 474), and transmits the message 490 to broadcast-contents-combined service providing apparatus 64. The broadcast-contents-combined service providing apparatus 64 executes the process in accordance with the message (step 476). Specifically, the apparatus 64 determines to which service the message corresponds based on the service determination information included in the message, and stores the answer information and elapsed time information included in the message in relation to each other.

The series of operations in the present embodiment is as described above.

<Implementation with a Computer Program>

The broadcast contents reproducing apparatus 50 and sub-contents reproducing apparatus 52 described above can substantially be implemented with hardware having the same functional portions as a computer and a computer program executed by the computer.

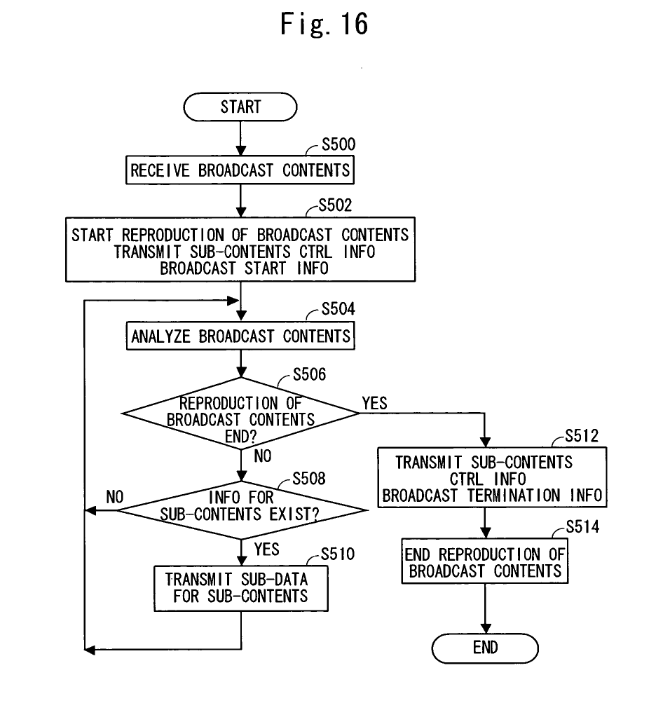

FIG. 16 is a flowchart representing a computer program realizing the broadcast contents reproducing apparatus 50. Referring to FIG. 16, when reproduction of broadcast contents is designated in broadcast contents reproducing apparatus 50, broadcast contents are received in step (hereinafter simply denoted by “S”) 500.

Then, in S502, reproduction of the received broadcast contents starts. At the start of the broadcast contents, there may be sub-contents control information such as sub-contents control information 390 shown in FIG. 13. In S502, such sub-contents control information included in the broadcast contents are separated from the AV data, and transmitted to sub-contents reproducing apparatus 52.

In S504, the broadcast contents are analyzed. In S506, whether reproduction of broadcast contents should be terminated or not is determined. If reproduction is to be terminated, the flow proceeds to S512, otherwise, to S508.

In S508, whether the broadcast contents include broadcast contents sub-data or not is determined. If broadcast contents sub-data are included, the flow proceeds to S510. If not, the flow returns to S504, and analysis of broadcast contents continues.

In S510, the broadcast contents sub-data are transmitted to sub-contents reproducing apparatus 52, and the flow returns to S504.

If it is determined in S506 that reproduction of broadcast contents is to be terminated, the sub-contents control information (such as sub-contents control information 430 of FIG. 13) at the end of the program included in the broadcast contents is transmitted to sub-contents reproducing apparatus 52 in S512.

Reproduction of broadcast contents ends in S514.

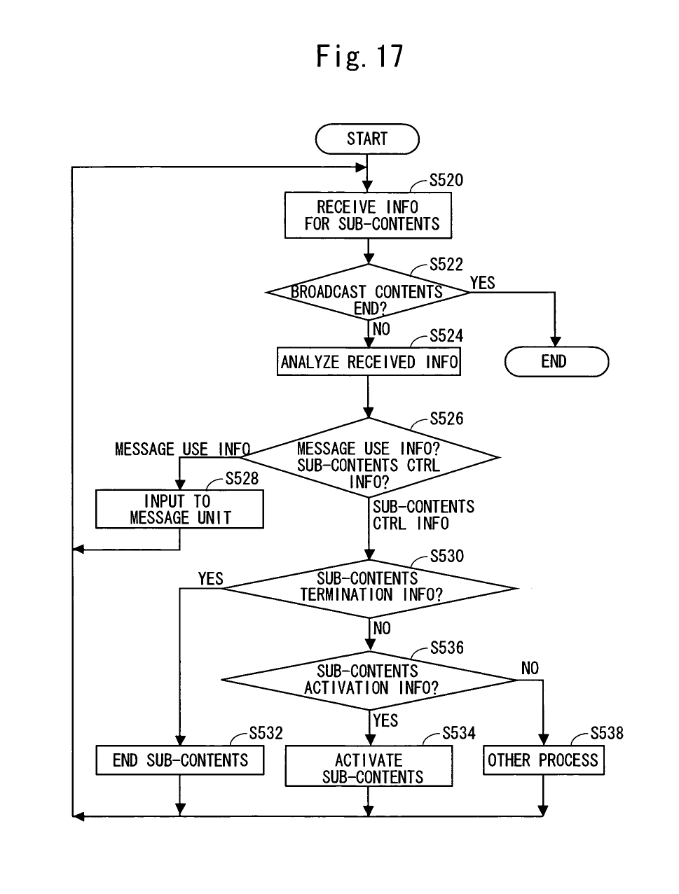

FIG. 17 is a flowchart representing the process of sub-contents reproducing apparatus 52. When reproduction of sub-contents starts, sub-contents reproducing apparatus 52 receives the broadcast contents sub-data from broadcast contents reproducing apparatus 50 in S520.

In S522, whether the broadcast contents sub-data received in S520 is information designating end of broadcast contents or not, that is whether it is designated as the end information in any of the pieces of sub-contents control information or not is determined. If it designates the end of broadcast contents, the operation of sub-contents reproducing apparatus 52 ends. If not, the flow proceeds to S524.

In S524, the broadcast contents sub-data received from broadcast contents reproducing apparatus are analyzed.

In the following step S526, based on the result of analysis in S524, whether the broadcast contents sub-data is the message use information or not is determined. If it is the message use information, the flow proceeds to S528, and if it is the sub-contents control information, the flow proceeds to S530.

In S528, using the received message use information, the information necessary for the message portion in the sub-contents is set. If it is the information message use information that represent elapsed time such as message use information 412 shown in FIG. 13, a variable for storing the message use information is pre-set to “time” (or the variable name is designated in message use information 412), and the received message use information is stored in the variable. Every time a new piece of message use information is received, the corresponding variable value is updated by the value of the newly received message use information. By such settings, it becomes possible to refer to the value of latest received message use information from any module within the system.

In S530, whether the received sub-contents control information is the control information related to termination of sub-contents (sub-contents termination information) or not is determined. Specifically, if the received sub-contents control information matches any of the descriptions in sub-contents termination determination information 272 of sub-contents. If the sub-contents control information is the sub-contents termination information, the flow proceeds to S532, and otherwise, to S536.

In S532, reproduction of sub-contents that has the sub-contents termination determination information that matches the received sub-contents termination information is terminated, and the flow returns to S520.

In S 536, whether there are any sub-contents that has sub-contents activation determination information matching the received sub-contents control information or not is determined. If the result of determination is YES, the flow proceeds to S534, and if not, to S538.

In S534, reproduction of sub-contents that have the sub-contents activation determination information matching the received sub-contents activation information starts. After activation of the sub-contents, the flow returns to S520.

In S536, as the received sub-contents control information includes information designating the template of the message, the designated template is read from the sub-contents and applied to the formatting unit 176. Then, the flow returns to S520.

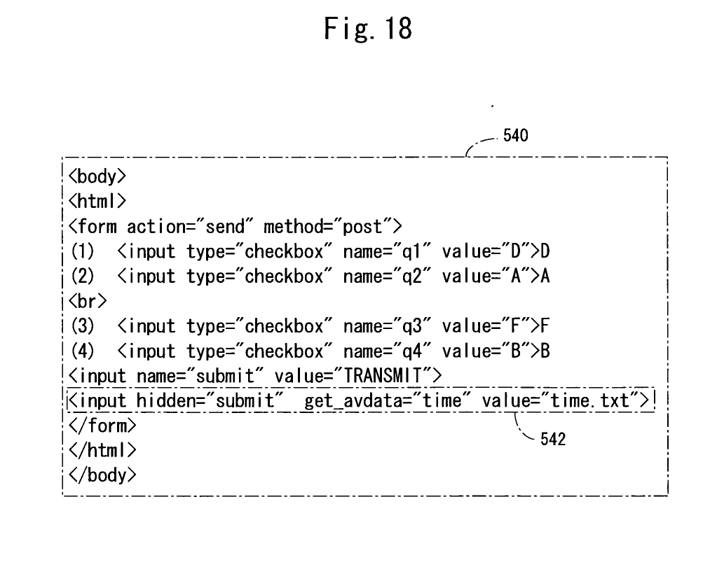

FIG. 18 shows an html document 540, which is an example of the html document “answer.html” (designated by the “src” attribute of sub-contents activation determination information 300 of FIG. 9) displayed in the region 354 of FIG. 12, in sub-contents reproducing apparatus 52. In this example, a form for answering represented by the html document 540 is displayed on region 354, and when any of the selection button is pressed, message use information 412 is obtained form the broadcast contents sub-data received from broadcast contents reproducing apparatus 50 at that time, to be reflected on the message of sub-contents. In such a case, sub-contents activation determination information 300 (see FIG. 9) is adapted to have a “message” attribute (“message=”), and the variable or a file indicated by the attribute is used for data exchange. In the following, a specific example shown in FIG. 9 will be described.

The html document 540 shown in FIG. 18 includes an <input> tag 542. The <input> tag 542 indicates a hidden field, and as “get_avdata” attribute, “time” is designated, and as value attribute, “time.txt” is designated. As already described, when message use information 412 is received, the variable “time” is updated successively, dependent on the value. When any of the selection button displayed on the answer image is pressed, the value of variable “time” designated by “get_avdata” attribute at that time is temporarily stored in “time.txt” document. The name of this document is determined beforehand to be variable+“.txt”.

By this configuration, when the form designated by html document 540 is displayed on the region 354 as shown in FIG. 12 and any of the selection buttons is pressed by the user, the time information defined by the message use information received at that time is passed to the html document 540, through the variable “time” and the document “time.txt”. Further, when the user pressed button 355, a message is formed in a prescribed format in formatting unit 176 shown in FIG. 6, and transmitted to broadcast-contents-combined service providing apparatus 64.

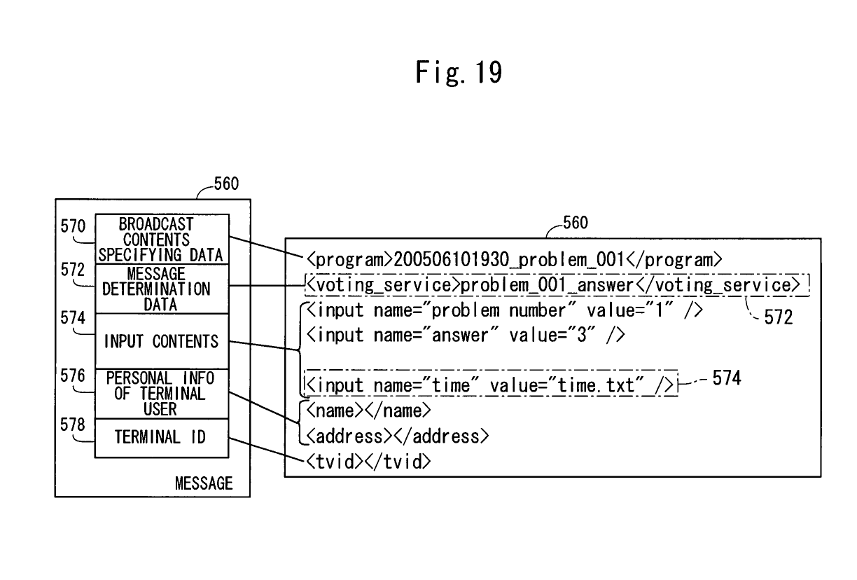

FIG. 19 shows structure of a message formed by message formatting unit 176 in sub-contents reproducing apparatus 52 shown in FIG. 6 and an example of the message. The message structure as a base thereof is also obtained in advance by sub-contents reproducing apparatus 52 as sub-contents data as message information 241A shown in FIG. 10.

Referring to the left side of FIG. 19, a message 560 includes broadcast contents specifying data 570 specifying the broadcast contents, message determination data 572 representing to which service the message corresponds, user-input contents 574, personal information 576 of the user of the terminal, and a terminal ID 578.

The corresponding specific message is as shown on the right side of FIG. 19. In message 560, in addition to the value described in the template indicated by message information 241A of FIG. 10, an input value (“3”) is placed as the “value” attribute of the input tag having the “name” attribute of “answer”, and as the “value” attribute of <input> tag 574 having the “name” attribute of “time”, the elapsed time information obtained by tag 542 in FIG. 18 is placed. In FIG. 19, a file name is placed as the “value” attribute. At the time of actual transmission of the message, the value in the file is placed here. The message 560 formed in this manner is transmitted from formatting unit 176 shown in FIG. 6 through message transmitting unit 178 to broadcast-contents-combined service providing apparatus 64.

By the above-described configuration, the broadcast contents and sub-contents combined service system can be realized.

<Operation>

The broadcast-contents-combined service providing apparatus 64 operates as follows. Assume that the broadcast contents sub-data and AV data are formed beforehand by broadcast contents forming apparatus 60 and packed by broadcast contents forming unit 84 to be the broadcast contents. Further, it is assumed that the sub-contents are formed in advance by sub-contents forming apparatus 62. Still further, it is assumed that the sub-contents received by sub-contents receiving unit 112 from sub-contents forming apparatus 62 and the broadcast contents received by broadcast contents receiving unit 110 from broadcast contents forming apparatus 60 have been packed by contents packing apparatus 70 to form the contents, and that the thus formed contents have already been transmitted to broadcast contents reproducing apparatus 50. Further, the contents packing apparatus 70 shown in FIG. 3 packs the sub-contents received by sub-contents receiving unit 112 and the broadcast contents received by broadcast contents receiving unit 110 to form the contents to be actually broadcast, and stores the thus formed contents.

By sub-contents forming apparatus 62, the sub-contents may be distributed both through the network 46 and through the broadcaster 44. Therefore, the portable terminal 48 in accordance with the present embodiment may receive in advance the sub-contents directly from the sub-contents forming apparatus 62 through the network 46, or it may receive in advance the sub-contents through the broadcast provided by the broadcaster 44. The received sub-contents are stored in sub-contents storing unit 162 shown in FIG. 6.

When it comes to the prescribed time of broadcast for the program, contents transmitting unit 116 reads the contents from contents packing unit 114 and applies them to relay station 72 for broadcast. Broadcast contents reproducing apparatus 50 receives the broadcast.

Referring to FIG. 5, broadcast receiving unit 130 of broadcast contents reproducing apparatus 50 applies the received contents to the first input of selecting unit 133 and to contents storing unit 132. When the broadcast contents are to be reproduced immediately, selecting unit 133 applies the contents from broadcast receiving unit 130 to contents analyzing unit 134, in accordance with the settings. If the settings are to store the contents, selecting unit 133 does not apply the contents from broadcast receiving unit 130 to contents analyzing unit 134. Contents storing unit 132 stores the contents from broadcast receiving unit 130.

The stored contents are reproduced and applied to contents analyzing unit 134 by designation through input unit 140. In the following, an operation when contents selected by selecting unit 133 are applied to contents analyzing unit 134 will be described.

Contents analyzing unit 135 separates the AV data and associated data of the contents, and applies the AV data to AV data reproducing unit 136 and the associated data to associated data transmitting unit 138, respectively. AV data reproducing unit 136 reproduces the AV data, and applies video and audio signals to output unit 142.

Receiving the associated data from contents analyzing unit 134, associated data transmitting unit 138 transmits the associated data to sub-contents reproducing apparatus 52.

Referring to FIG. 6, associated data receiving unit 166 separates the received associated data to broadcast contents sub-data and sub-contents data, and applies the broadcast contents sub-data and sub-contents data to broadcast contents sub-data analyzing unit 168 and sub-contents storing unit 162, respectively.

If the sub-contents applied from associated data receiving unit 166 has already been stored, sub-contents storing unit 162 discards the sub-contents. If they are not yet stored, sub-contents storing unit 162 stores the sub-contents, so that they can be read later.

Receiving the broadcast contents sub-data from associated data receiving unit 166, broadcast contents sub-data analyzing unit 168 separates the data into sub-contents control information and message use information, and applies these to sub-contents reproduction control unit 170 and formatting unit 176, respectively. Formatting unit 176 stores the message use information, to be ready for message transmission later. For instance, if the message use information is time information related to the variable “time”, the value of the variable is updated by message use information.

When the sub-contents control information is applied from broadcast contents sub-data analyzing unit 168, sub-contents reproduction control unit 170 causes sub-contents storing unit 162 to output the sub-contents corresponding to the sub-contents control information to sub-contents analyzing unit 164. Sub-contents analyzing unit 164 analyzes the sub-contents, and applies the result of analysis to sub-contents reproduction control unit 170. In accordance with the result of analysis, sub-contents reproduction control unit 170 controls message obtaining unit 180, sub-contents layout unit 172 and formatting unit 176, to execute necessary processes.

For instance, if the sub-contents control information indicates start of a program, sub-contents reproduction control unit 170 controls sub-contents layout unit 172 such that the designated contents are displayed at the output unit 142 in a designated layout, in accordance with the sub-contents control information. If the sub-contents control information indicates display of a URL page, sub-contents reproduction control unit 170 controls message obtaining unit 180 such that the information of the designated URL is obtained, and applies the obtained information to sub-contents layout unit 172 to be displayed in a designated layout. When the sub-contents control information indicates a timing of transmission of a message, sub-contents reproduction control unit 170 controls the formatting unit 176 such that a message is formed from the message template that has already been stored, the message use information, and the user-input contents input through message input unit 174 from sub-contents layout unit 172, and that the message is transmitted through message transmitting unit 178. If the sub-contents control information is the information designating the message template, the corresponding template is read from sub-contents storing unit 162 shown in FIG. 6 and applied to formatting unit 176.

In this manner, every time the broadcast contents sub-data analyzing unit 168 receives the message use information, the contents stored in formatting unit 176 are updated, and every time it receives the sub-contents control information, the display of sub-contents is controlled, and such operations are repeated.

If the received contents indicates termination of the program, sub-contents reproduction control unit 170 control the sub-contents reproducing apparatus 52 as a whole, and terminates reproduction of the sub-contents.

In this manner, in accordance with the example described above, the portable terminal 48 displays the quiz image and the broadcast image based on the display layout designated by the sub-contents corresponding to the sub-contents control information, and switches the display layout based on the sub-contents control information of the broadcast contents.

When the viewer (user of portable terminal 48) presses an answer selection button for the quiz in the period of quiz giving portion 374 of FIG. 13, for example, the information necessary to form a message is obtained from the message use information, a value corresponding to the selected button is set in the “value” attribute of the input tag having the “answer” attribute in the message template, and the value of variable “time”, at that time is obtained and stored in the file “time.txt”. When the user presses the transmission button (button 355 shown in FIG. 12), portable terminal 48 forms the message based on the message template, and transmits the message to broadcast-contents-combined service providing apparatus 64. As already described, the message includes the information of the answer to the question selected by the user, and the elapsed time information from when the question was putted to the selection of the answer (when the selection button was pressed).

Broadcast-contents-combined service providing apparatus 64 determines whether the question is correct or not, based on the answer information in the message received from portable terminal 48. Further, broadcast-contents-combined service providing apparatus 64 ranks the fastest fingers among the users, from the elapsed time information included in the received message. Broadcast-contents-combined service providing apparatus 64 may collect such results and provide a message indicating the results to portable terminal 48, or may form a page that can be accessed at an appropriate URL. Thus, the viewer can easily know the result of his/her voting while enjoying the broadcast.

In the sub-contents formed by sub-contents forming apparatus 62, destination data indicating the broadcast-contents-combined service providing apparatus 64 is included, and the message indicating the result of input by the user is transmitted to the destination. Further, in the message from the user, service determination information for determining the corresponding service is included. Therefore, the program producer can receive and save the messages from portable terminals 48 by a desired service providing apparatus, service by service. As a result, the program producer can directly gauge viewer response to the program, and to directly provide various services to the viewer in accordance with the contents of the messages.

In the present embodiment, the program producer forms various contents and services and provides the broadcast-contents-combined service providing apparatus 64. The present invention, however, is not limited to such an embodiment. By way of example, the broadcaster and the program producer may form services separately. In that case, the broadcaster and the program producer may prepare sub-contents data having destination data satisfying their separate requests, so that the services can be used (provided) freely by each other. The broadcaster may form and distribute all the contents. Alternatively, the program producer may have only the broadcast contents forming apparatus, and a separate service provider may have the sub-contents forming apparatus and broadcast-contents-combined service providing apparatus, and in that case also, the service in accordance with the contents formed by the program producer can be provided by the service provider.

In the present embodiment, sub-contents 230 are described in the XML format. The contents may be described in the HTML (Hyper Text Markup Language) format, XHTML (eXtensible Hyper Text Markup Language) format, SMIL (Synchronized Multimedia Integration Langage) format or any other description format or combination thereof.

In the embodiment above, the portable terminal 48 is a portable telephone. The present invention, however, is not limited to such an embodiment, and as the portable terminal, an information terminal that can be connected to a network, such as a note PC or a PDA (Personal Digital Assistant) may be used. Further, the terminal that can be used is not limited to a portable terminal. Any device that has functions comparable to the portable terminal 48 described above may be used, no matter whether it is portable or not. For example, a TV receiver or a desktop PC may be used as the terminal. In the present embodiment, however, use of a portable telephone as the terminal 48 is preferred. As the communication network 46, a mobile communication network, telephone network, the Internet, LAN (Local Area Network) or other known communication network may be used. Though one portable terminal includes both the broadcast contents reproducing apparatus 50 and sub-contents reproducing apparatus 52 in the present embodiment, these apparatuses may be arranged on separate terminals.

In the above-described embodiment, the sub-contents include either the reproduction data that are reproduced in association with the broadcast contents or reproduction data that are reproduced independent from the broadcast contents. The present invention, however, is not limited to such an embodiment, and neither of the data may be included. Further, one or a plurality of different types of sub-contents may be included in one broadcast content.

In the above-described embodiment, though the broadcast contents and the sub-contents are packed, they are the separate data. The present invention, however, is not limited to such an embodiment, and the sub-contents may be included in the data of the broadcast contents and transmitted together. In that case, it becomes necessary for broadcast contents reproducing apparatus 50 to have the function of analyzing the received data and separating the broadcast contents from the sub-contents.

Further, in the above-described embodiment, the sub-contents are transmitted from sub-contents forming apparatus 62 to contents packing apparatus 70, and further broadcast by the broadcaster 44, and in addition, the sub-contents may also be directly distributed from sub-contents forming apparatus to the portable terminal 48. The present invention, however, is not limited to such an embodiment, and transmission of either one of the above-described routes may be possible and the other may be prohibited.

In the first embodiment, the display layout is switched automatically in accordance with the sub-contents control information. The present invention is not limited to such an embodiment, and the display layout may be switched by a manual operation by the user.

Further, the message transmitted from sub-contents reproducing apparatus 52 to broadcast-contents-combined service providing apparatus 64 includes the personal information and mail address that are set in advance for the portable terminal in the embodiment above. These information, however, may not be included in some situations. Further, as the message use information, arbitrary information desired by the program producer, such as a text string or graphic image may be used.

In the present embodiment, the start of a program is also determined by the sub-contents activation information. Therefore, it is necessary to distribute the sub-contents before the start of the program. It is possible, however, to distribute the sub-contents through the relay station 72 or communication network 46, at the start of the program, as described above. In that case, the start of the program is not determined by the sub-contents activation information.

### Second Embodiment

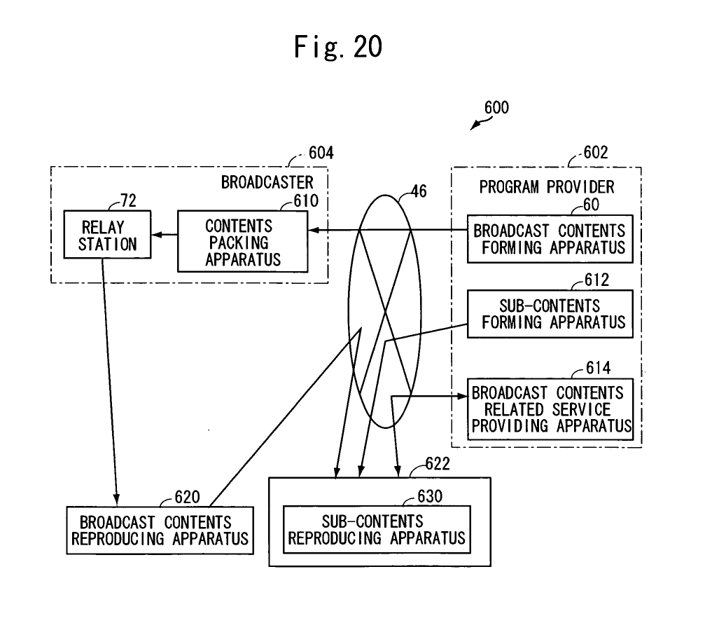

Next, the broadcast-contents-combined service system in accordance with the second embodiment of the present invention will be described with reference to FIGS. 20 to 29. Referring to FIG. 20, a broadcast-contents-combined service system 600 in accordance with the present embodiment allows a user to use a service provided from the Web while watching a TV program and to enjoy the same web-service as that enjoyed by performers appearing on the TV program. More specifically, the broadcast-contents-combined service system 600 in accordance with the present embodiment relates to an improvement of a program, in which hosts of the program talk to panelists at a TV studio about very trivial but surprising facts, the panelists punch buttons called “fe-button” to register their degree of disbelief in units called “fe”, and the degree of surprise of the trivial facts is appreciated by the total number of “fe” units. Specifically, the broadcast-contents-combined service system 600 in accordance with the present embodiment allows not only the panelists at the studio but also the viewer of the TV to click (press) the “fe-button” displayed on a portable terminal 622 at hand, as many times as considered appropriate to express his/her degree of disbelief on the presented fact. The total number of pressing by nation-wide viewers would be the appreciation of how surprising the fact is. This scheme allows not only the performers at the studio but also nationwide television audience to participate in the program, and to share the result among the viewers.

<Configuration>

Referring to FIG. 20, the broadcast-contents-combined service system 600 is provided by a program producer 602 and a broadcaster 604. Program producer 602 has broadcast contents forming apparatus 60 and, in addition, a sub-contents forming apparatus 612 similar to but having functions slightly different from sub-contents forming apparatus 62 of the first embodiment, and a broadcast-contents-combined service providing apparatus 614 similar to but having functions slightly different from broadcast-contents-combined service providing apparatus 64 of the first embodiment. Similarly, broadcaster 604 has, in addition to relay station 72 in accordance with the first embodiment, a contents packing apparatus 612 similar to but having functions slightly different from contents packing apparatus 70 of the first embodiment. Sub-contents forming apparatus 612 and contents packing apparatus 610 will be described later.

The broadcast-contents-combined service system 600 further includes one or a plurality of broadcast contents reproducing apparatus 620 that can be connected to the network 46, and one or a plurality of portable terminals 622 that can also be connected to the network 46.

Broadcast contents reproducing apparatus 620 has a function of receiving broadcast contents from broadcast contents packing/transmitting apparatus 610 through relay station 72 and reproducing the same. In the present embodiment, the contents reproducing apparatus is typically a TV receiver. Functionally, the broadcast contents reproducing apparatus 620 is the same as broadcast contents reproducing apparatus 50 in accordance with the first embodiment.

Portable terminal 622 includes sub-contents reproducing apparatus 630. Functionally, sub-contents reproducing apparatus 630 is similar to sub-contents reproducing apparatus 52 of the first embodiment, and it has a function of receiving the sub-contents from broadcasting contents packing/transmitting apparatus 610 through relay station 72 and reproducing the same.

In the present embodiment, broadcast contents reproducing apparatus 620 and sub-contents reproducing apparatus 630 do not exist in one same apparatus (such as portable terminal 48 in the first embodiment), but these are separate apparatuses and can communicate to each other through the network 46, and in this point these apparatuses are different from those of the first embodiment. Further, as the broadcast contents reproducing apparatus 620 and sub-contents reproducing apparatus 630 are separate from each other, sub-contents reproducing apparatus 630 receives the sub-contents not from the broadcast provided by broadcaster 604 but directly from sub-contents forming apparatus 612. When the received broadcast contents include broadcast contents sub-data, broadcast contents reproducing apparatus 620 transmits the broadcast contents sub-data to sub-contents reproducing apparatus 630 through the network 46.

In the present embodiment also, sub-contents reproducing apparatus 630 is capable of receiving and storing the sub-contents in advance, forming a message reflecting a user input based on a message template existing in the sub-contents and transmitting the message to a prescribed destination.

Portable terminal 622 of the present embodiment receives and stores in advance the sub-contents from sub-contents forming apparatus 612. Receiving the sub-contents control information from broadcast contents reproducing apparatus 620, portable terminal 622 reads display layout information designated by the sub-contents control information from the sub-contents, and based on the display layout information, displays contents based on the sub-contents. Therefore, in the broadcast-contents-combined service system 600, at an appropriate timing in association with the broadcast contents that are being broadcast, appropriate information related to the broadcast contents can be displayed by sub-contents reproducing apparatus 630 based on the sub-contents. Therefore, in the present embodiment, using the sub-contents control information, a prescribed message may be transmitted from sub-contents reproducing apparatus 630 to broadcast-contents-combined service providing apparatus 614 or a request for a prescribed message may be issued to broadcast-contents-combined service providing apparatus 614.

Accordingly, the control information in broadcast contents sub-data includes, in addition to the pieces of information used in the first embodiment, pieces of control information for determining timings of transmitting a message or requesting a message, based on determination using message transmission determining information 670 and message request determining information 672. In the following, these pieces of information will be referred to as “message transmission information” and “message request information”, respectively.

In the following, details of various configurations in the broadcast-contents-combined service system 600 in accordance with the present embodiment will be described. Sub-contents forming apparatus 612, broadcast contents reproducing apparatus 620 and broadcast-contents-combined service providing apparatus 614 may be implemented by only slightly modifying the sub-contents forming apparatus 62, contents packing apparatus 70 and broadcast-contents-combined service providing apparatus 64 of the first embodiment, respectively. Therefore, detailed descriptions thereof will not be given here.

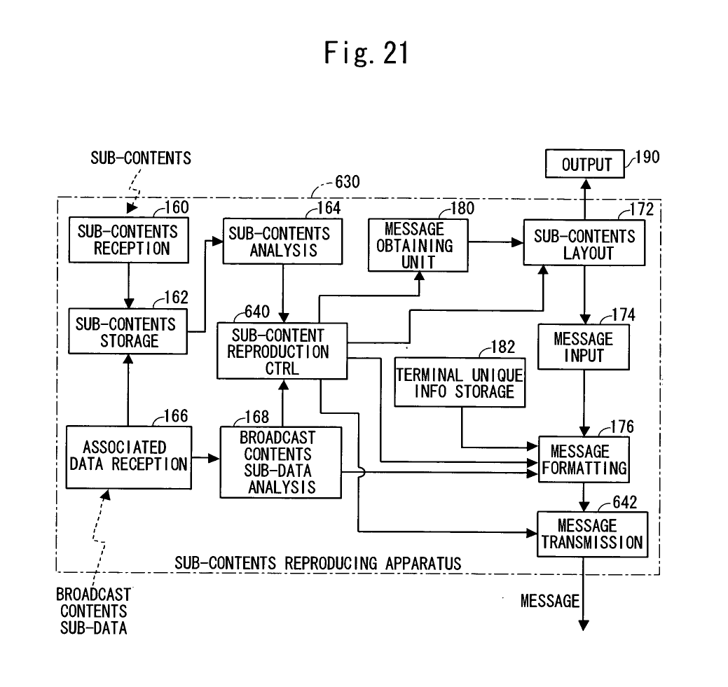

FIG. 21 schematically shows configuration of sub-contents reproducing apparatus 630. Sub-contents reproducing apparatus 630 has configuration similar to that of the first embodiment. It is different in that it includes a sub-contents reproduction control unit 640 in place of sub-contents reproduction control unit 170 of the first embodiment, and a message transmitting unit 642 in place of message transmitting unit 178. Details of sub-contents reproduction control unit 640 and message transmitting unit 642 will be described next.

Sub-contents reproduction control unit 640 has a function of comparing the sub-contents control information received from broadcast contents sub-data analyzing unit 168 with the sub-contents control determination information included in the sub-contents, and if the sub-contents control information matches any of the sub-contents control determination information, forming a piece of corresponding control information based on the sub-contents, and transmitting the information to various portions in sub-contents reproducing apparatus 630. The function itself is the same as the function of sub-contents reproduction control unit 170 of the first embodiment. It is noted, however, that the sub-contents reproduction control unit 640 additionally has a function of applying, when the message transmission information is received, the message transmission information to message transmitting unit 642, and applying, when a message request information is received, the message request information to message transmitting unit 642.

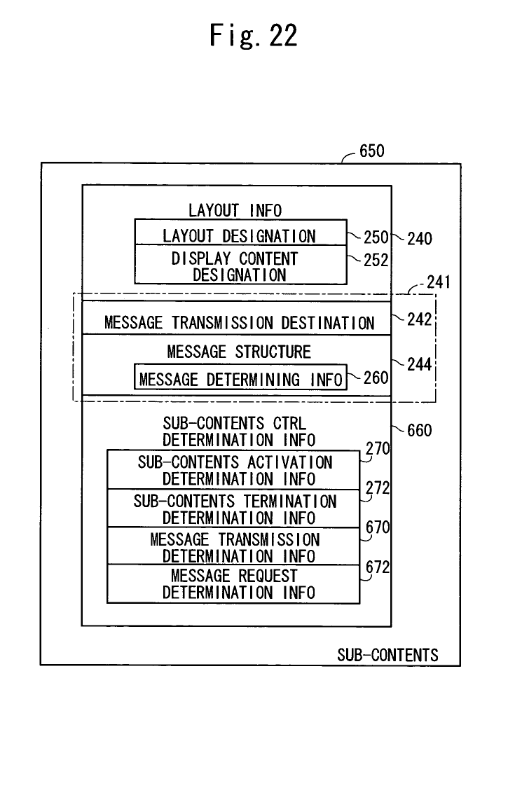

Message transmitting unit 642 has functions similar to those of message transmitting unit 178 of the first embodiment and, in addition, has a function of transmitting, when the message transmission information received from sub-contents reproduction control unit 640 matches the determination condition in accordance with the message transmission determination in formation 670 (see FIG. 22), the corresponding message to broadcast-contents-combined service providing apparatus 614.

Further, message transmitting unit 640 has a function of requesting, when the message request information matches the determination condition in accordance with the message request determination information 672 (FIG. 22), the broadcast-contents-combined service providing apparatus 614 for the latest data of the corresponding sub-contents.

FIG. 22 shows the configuration of the contents used in the present embodiment. Referring to FIG. 22, sub-contents 650 includes the same layout information 240 and message information 241 as the first embodiment. Sub-contents 650 further includes, in place of sub-contents control determination information of the first embodiment, sub-contents control determination information 660.

The configuration of sub-contents control determination information 660 includes, in addition to sub-contents activation determination information 270 and sub-contents termination determination information 272 similar to those included in sub-contents control determination information 246, message transmission determination information 670 for determining whether it is a timing of transmitting a prescribe message to broadcast-contents-combined service providing apparatus 614, and message request determination information 672 for determining whether it is a timing of requesting a prescribed message from broadcast-contents-combined service providing apparatus 614.

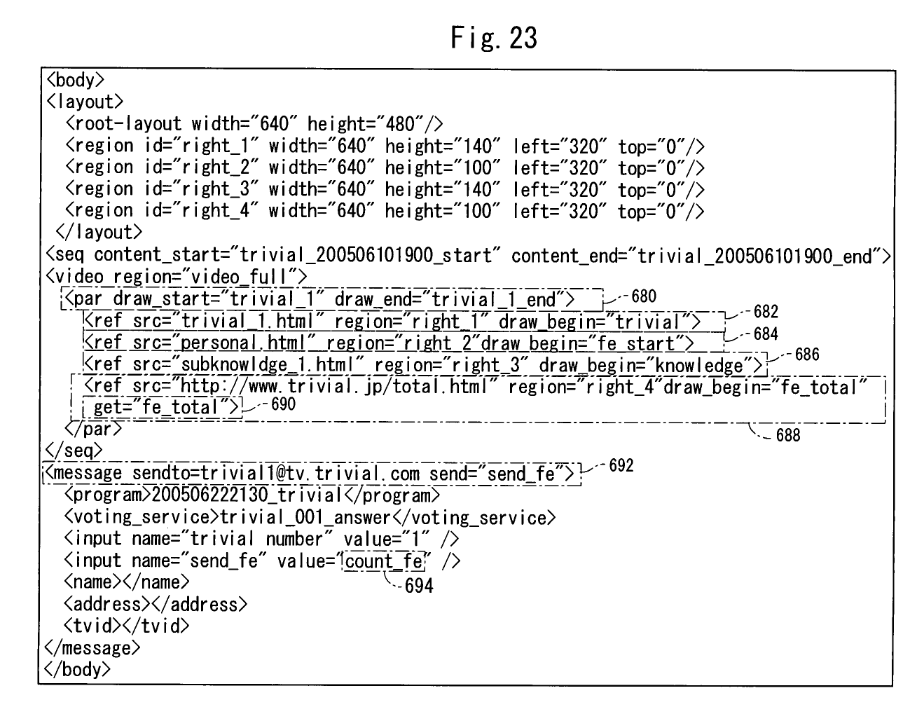

FIG. 23 shows a more specific example of sub-contents 650. It is noted that the exemplary descriptions in FIG. 23 are simplified for easier understanding of the present embodiment.

Descriptions in the <layout> tag are the same as in the first embodiment.

Pieces of display contents designating information are described in <seq> tag and <par> tag. The meanings of these descriptions between the tags are the same as those of the first embodiment. In the example shown in FIG. 23, between <par> tag 680 and </par> tag, pieces of display contents designating information 682, 684, 686 and 688 designating “video”, “trivial_{—}1.html”, “personal.html”, “subknowledge_{—}1.html” and “total.html”, respectively, are designated, together with “region” attribute designating regions where these contents are to be displayed.

In the present embodiment, “get” attribute is described in sub-contents activation determination information 690. The value of this attribute is the message request determination information. In the example shown in the figure, when “fe_total” is received as the message request information, transmission of the message requesting the message is executed, as it matches the message transmission determination information of sub-contents activation determination information 690. In the present embodiment, the “draw_begin” attribute of display contents designating information 688 and the “get” attribute 690 are adapted to have the same value (“fe_total”), and therefore, when the sub-contents control information (message request information) is obtained, the contents designated by the display contents destination information 688 is activated, and the message request is transmitted. As these pieces of information are determined independent from each other, the timing of activation of the contents may be set different from the timing of transmitting the message request, by setting different values.

Sub-contents control determination information 660 further includes message structure information that begins with <message> tag 692. In <message> tag 692, in addition to “sendto” attribute indicating an address of transmission destination of the message, a piece of information designating the sub-contents control information determining the timing of transmitting the message, as “send” attribute. The value of “send” attribute is the message determination information. In the example shown in FIG. 23, the value of “send” attribute is “send_fe”. Specifically, when the sub-contents control information (message transmission information) of “send_fe” is received, the message is transmitted to the destination indicated by the “sendto” attribute, as the information matches the condition indicated by the message transmission determination information.

In the example shown in FIG. 23, <program> tag, <voting_service> tag, <input> tag, <name> tag, <address> tag and <tvid> tag are described in the message structure information that begins with <message> tag. Meanings of these descriptions are approximately the same as those of the first embodiment.

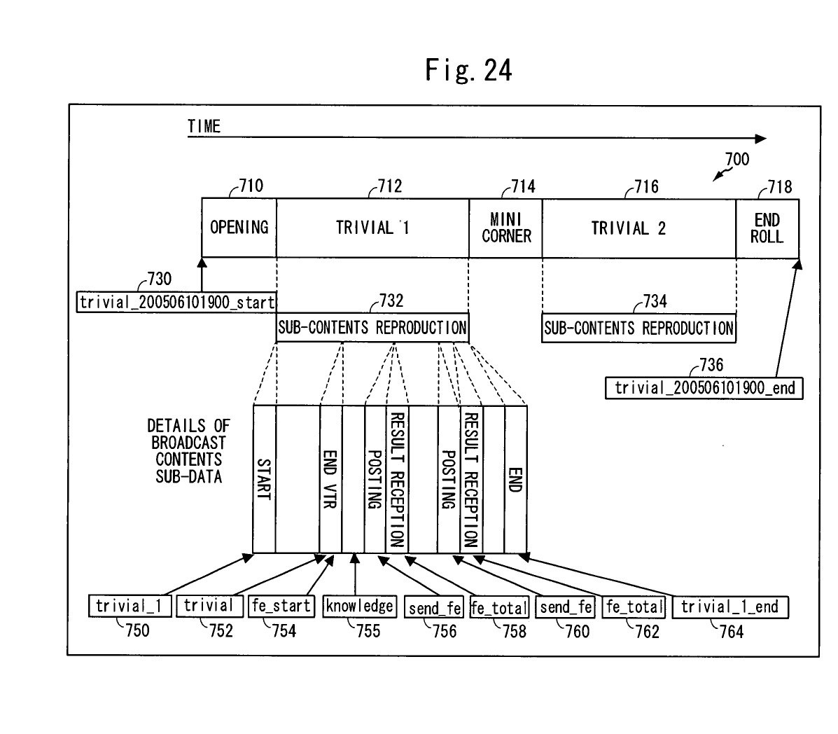

Referring to FIG. 24, details of the broadcast contents sub-data held by the broadcast contents will be described. Referring to FIG. 24, broadcast contents 700 has contents of an audience participation and voting program arranged in time sequence. Broadcasting contents 700 includes an opening portion 170 of the program, a portion 712 of a first trivial fact 712, a mini corner 714 following the portion 712 of the first trivial fact, a portion 716 of a second trivial fact, and an end roll portion 718 displayed after the portion 716 of the second trivial fact.

At the start of the broadcast contents, there is sub-contents control information 730 of “trivial_{—}1”. Following this, the portion 712 of the first trivial fact starts. In the following, the arrangement of sub-contents control information in the sub-contents reproducing region 732 corresponding to the portion 712 of the first trivial fact will be described.

After a prescribed time period from sub-contents control information 730, sub-contents control information 752 of “trivial” is arranged, immediately followed by sub-contents control information 754 of “fe_start”. Sub-contents control information 752 is for starting reproduction of the sub-contents in accordance with the display contents designating information 682 shown in FIG. 23. Sub-contents control information 754 is for starting reproduction of the sub-contents in accordance with the display contents designating information 684 shown in FIG. 23.

Thereafter, there is some time period in which the viewers are allowed to press “fe” button that appear on the screen. At a prescribed point in this period, sub-contents control information 755 of “knowledge” is arranged. This is to display some knowledge related to the fact that is being broadcast, as sub-contents.

Thereafter, sub-contents control information 756 of “send_fe” is arranged. Sub-contents control information 756 determines the timing of transmitting the number of button-pressing to broadcast-contents-combined service providing apparatus 614 from sub-contents reproducing apparatus 630, so as to preliminarily count how many times the “fe” button has been pressed by nationwide audience, in broadcast-contents-combined service providing apparatus 614. Thereafter, sub-contents control information 758 of “fe_total” is arranged. Sub-contents control information 758 represents a timing of requesting broadcast-contents-combined service providing apparatus 614 for the message indicating the resulting count of “fe” button pressing.

Then, a time period for pressing the button is further secured, and at the end position thereof, sub-contents control information 760 of “send_fe” again is arranged. The function of sub-contents control information 760 is the same as that of sub-contents control information 754. Further, sub-contents control information 762 of “send_total” again is arranged. The function of sub-contents control information 762 is the same as that of sub-contents control information 758. It is noted, however, that the message obtained from broadcast-contents-combined service providing apparatus 614 here will be the final count of “fe” button pressing by the viewers.

Then, after a prescribed time period, sub-contents control information 764 of “trivial_{—}1_end” is arranged. Receiving this sub-contents control information, reproduction of the sub-contents in sub-contents reproducing region 732 ends.

Similar arrangement of pieces of sub-contents control information is prepared in sub-contents reproducing region 736 for the portion 716 of the second trivial fact. At the end of end roll portion 718, sub-contents control information 736 of “trivial_{—}200506101900_end” is arranged. Receiving this sub-contents control information, reproduction of broadcast contents 700 ends.

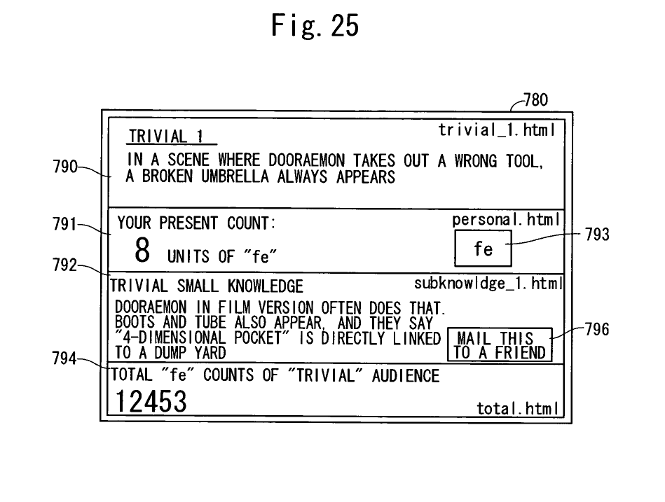

Transitions of sub-contents reproduction images in sub-contents reproducing region 732 will be described with reference to FIGS. 24 to 26. FIG. 25 shows a screen image 780 of sub-contents reproducing apparatus 630. The screen image 780 is divided into four regions 790, 791, 792 and 794. On region 790, “trivial_{—}1.html” is displayed in accordance with display contents designating information 682. On region 791, “personal.html” is displayed in accordance with display contents designating information 684. On region 792, “subknowledge.html” is displayed in accordance with display contents designating information 686. On region 794, “total.html” is displayed in accordance with display contents designating information 688.

When sub-contents control information 730 is received, reproduction (display) of the program starts. Specifically, display of the opening portion 710 starts. At the opening portion 710, the sub-contents are not displayed. At the end of the opening portion 710, sub-contents control information (sub-contents start information 750) is broadcast. Upon reception of the sub-contents start information 750, display of the portion 712 of the first trivial fact starts. This portion is the first audience-participating portion.

Of the portion 712 of the first trivial fact, only the VTR (Video Tape Recorder) image is broadcast at the initial portion. The video image is reproduced by broadcast contents reproducing apparatus 620. In sub-contents control determination information 660 shown in FIG. 23, even when the sub-contents control information 750 of “trivial_{—}1” is received, display on the sub-contents reproducing apparatus 630 is not given in this period, as there is no matching sub-contents activation information.

Thereafter, when sub-contents control information 752 of “trivial” is received, the sub-contents corresponding to the display contents designating information 682 is reproduced in accordance with sub-contents control determination information 660 shown in FIG. 23. More specifically, locally stored sub-contents “trivial_{—}1.html” is displayed (region 790 of FIG. 25). When sub-contents control information 754 of “fe_start” is further received thereafter, reproduction of the sub-contents starts, in accordance with the display contents designating information 684 of FIG. 23. Specifically, reproduction of the sub-contents information of “personal.html” starts (region 791 of FIG. 25). As shown in FIG. 23, on this image, the “fe” button and the number of pressing of this button by the viewers by that time are displayed. This period is provided for allowing the users to press the “fe” button.

When sub-contents control information 756 of “knowledge” is received during this period, the sub-contents control information matches the “draw_begin” attribute of display contents designating information 686 of sub-contents 650. Consequently, a document “subknowledge_{—}1.html” in the locally stored sub-contents, described in “src” attribute of display contents designating information 686 is displayed in region 792.

When sub-contents control information 756 (FIG. 24) of “send_fe” is transmitted during this period, the sub-contents information 756 matches the “send” attribute of message transmission determination information 692 in sub-contents 650 shown in FIG. 23, and therefore, message transmission is carried out. At this time point, the display image is not changed.

When sub-contents control information 758 of “fe_total” is received thereafter, sub-contents control information 758 of “fe_total” matches the “draw_begin” attribute of display contents designating information 688 in sub-contents 650 shown in FIG. 23. Therefore, a document for the corresponding display (“http://www.trivial.jp/total.html” designated by the “src” attribute of display contents designating information 688 for displaying the total) is obtained and displayed in region 794 of FIG. 25.

At the end of this voting period, sub-contents control information 756 of “send_fe” and sub-contents control information 758 of “fe_total” are again received. In response to these pieces of sub-contents control information, the message transmission and total display described above are repeated.

At the end of the portion 712 of the first trivial fact, when sub-contents control information 764 of “trivial_{—}1.end” is received, it matches the “draw_end” attribute in <par> tag 680 of FIG. 23, and therefore, display of the portion 712 of the first trivial fact in accordance with <par> tag 680 ends.

In this manner, as the image 780 is divided, and every time a piece of sub-content control information is received, the sub-contents control determination information that matches the sub-contents control information is searched for. In accordance with the description in the matching sub-contents control determination information, display/termination of sub-contents is controlled.

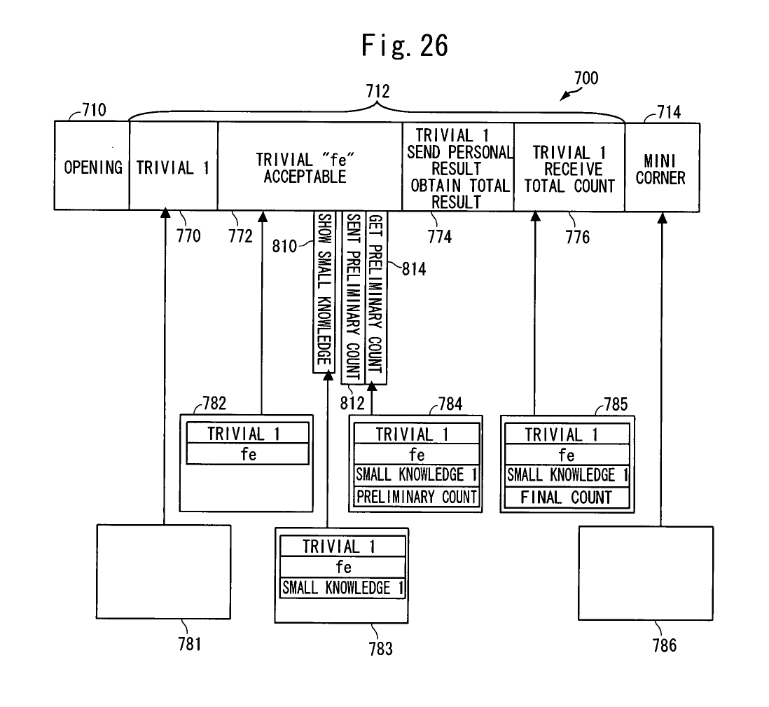

FIG. 26 represents a relation between broadcast contents 700 and transition of display images on sub-contents reproducing apparatus 630. Here, for simplicity reasons, descriptions of the pieces of transmitted sub-contents control information will not be repeated. Referring to FIG. 26, during the opening portion 710 and the initial portion 770 of the portion 712 of the first trivial fact, screen image 781 of sub-contents reproducing apparatus 630 is blank.

Next, an image 782 during the voting period 772 includes display of the trivial fact and a display of “fe” button. Image 782 includes displays on regions 790 and 791 shown in FIG. 25. Further, as a display 810 of small knowledge is inserted in the middle, the display of sub-contents reproducing apparatus 630 is changed to image 783. Image 783 includes displays of regions 790, 791 and 792 of FIG. 25.

Further, during the voting period 772, preliminary count of “fe” button pressing by the user is transmitted (812). The display does not change here. Thereafter, the preliminary count is obtained (814), and the display of region 794 of FIG. 25 is given. Therefore, the display of sub-contents reproducing apparatus 630 is changed to image 784 of FIG. 26. In image 784, sub-contents are displayed in every one of the four divided regions.

In the final period 774 of the voting period 772, a process similar to preliminary count transmission 812 is executed. In the following, count result reception period 776, a process similar to obtaining the preliminary count 814 is executed. The display of image 784 is updated by the results, to image 785. At the lowermost region of image 785, the final total of “fe” button pressing by all the viewers participating in the program is displayed.

Thereafter, when the portion 712 of the first trivial fact ends, the display of sub-contents reproducing apparatus 630 ends, and blank image 786 is resumed.

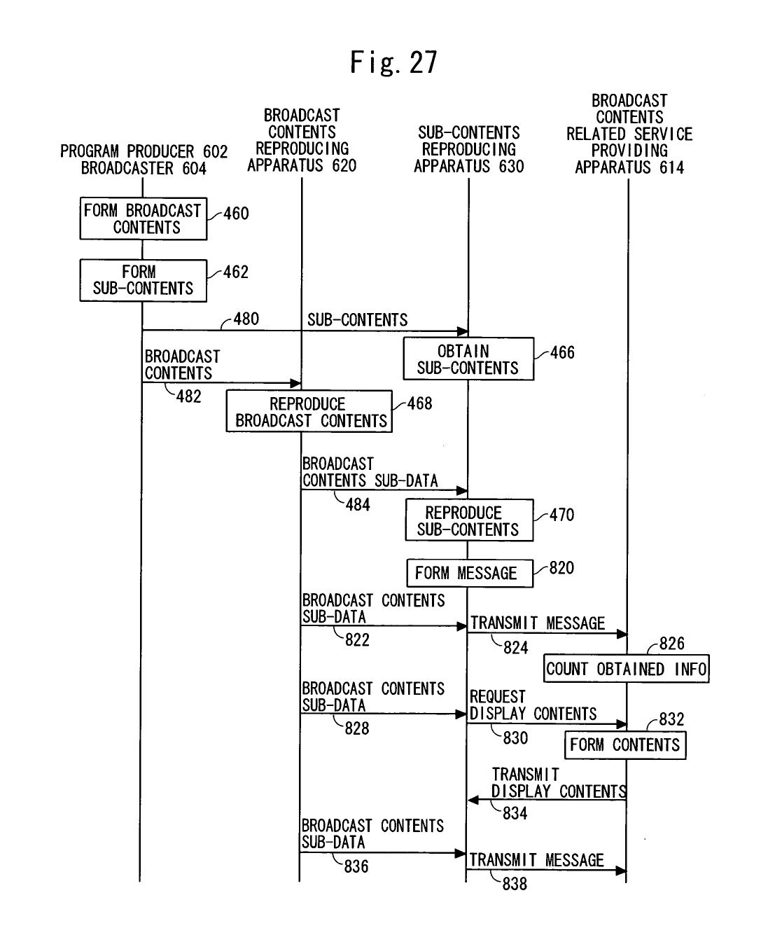

FIG. 27 is a process sequence diagram showing processes performed in various apparatuses of the present embodiment. Referring to FIG. 27, program producer 602 forms broadcast contents (step 460), and forms sub-contents associated with the broadcast contents (step 462). Sub-contents 480 are transmitted through the communication network 46 to contents reproducing apparatus 630 on or before the start of broadcast of the program (step 466).

When it comes to the time of starting program broadcast, broadcaster 604 transmits broadcast contents 482 to broadcast contents reproducing apparatus 620 through relay station 72. Broadcast contents reproducing apparatus 620 reproduces the broadcast contents (step 468), while it separates broadcast contents sub-data from the broadcast contents and transmits the sub-data to sub-contents reproducing apparatus 630 as needed (steps 484, 822, 828, 836). The broadcast content sub-data include sub-contents control information (sub-contents activation information, sub-contents termination information, message transmission information and message request information).

Sub-contents reproducing apparatus 630 receives the sub-contents control information and determines, in accordance with the sub-contents control determination information, which process should be applied to which sub-contents. By way of example, reproduction of sub-contents may be started in response to the broadcast contents sub-data, and a message may be formed, as represented by steps 470 and 820. Further, if the broadcast contents sub-data transmitted in step 822 is the message transmission information, a corresponding message is formed and transmitted to broadcast-contents-combined service providing apparatus 614 in step 824. In broadcast-contents-combined service providing apparatus 614, the number of “fe” button pressing is counted in response to the message (step 826).

If the broadcast contents sub-data transmitted in step 828 is the message request information, a message requesting for contents is transmitted to the broadcast-contents-combined service providing apparatus 614, in accordance with the display contents designating information matching the message request information (step 830). In the present embodiment, broadcast-contents-combined service providing apparatus 614 forms corresponding contents (count result) in response to the request (step 832), and transmits the formed contents to sub-contents reproducing apparatus 630 (step 834).

Further, in response to the next message transmission information transmitted in step 836, a message is transmitted to broadcast-contents-combined service providing apparatus 614 (step 838).

The series of operations of the present embodiment is as described above.

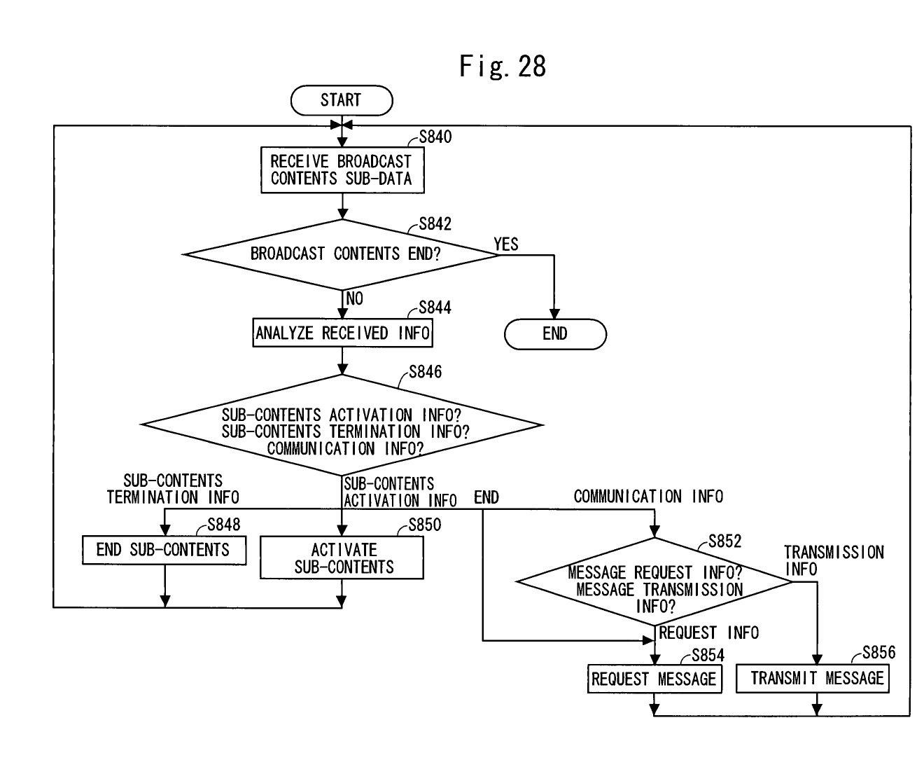

FIG. 28 is a flowchart showing control structure of a computer program when sub-contents reproducing apparatus 630 in accordance with the present embodiment is implemented by computer hardware and the computer program.

Referring to FIG. 28, when reproduction of sub-contents by sub-contents reproducing apparatus 630 starts, at S840, broadcast contents sub-data are received from broadcast contents reproducing apparatus 620.

At S842, whether the broadcast contents sub-data received in S840 is a piece of information of broadcast contents termination or not is determined. If termination of reproduction of the broadcast contents is designated by the broadcast contents sub-data, the operation of sub-contents reproducing apparatus 630 is terminated. If not, the flow proceeds to S844.

In S844, the sub-contents control information received from the broadcast contents reproducing apparatus is analyzed.

In S846, based on the result of analysis of the sub-contents control information, the flow branches to the following four processes, dependent on the type of sub-contents control information. Specifically, if the sub-contents control information is the sub-contents activation information, the flow proceeds to S850. If it is the sub-contents termination information, the flow proceeds to S848. If it is the message communication information (message request information and message transmission information), the flow proceeds to S852. If it is control information for terminating reproduction of sub-contents, the flow proceeds to S854.

In S850, based on the received sub-contents activation information and the sub-contents activation determination information held by the sub-contents, whether the display of sub-contents is possible or not is determined, and reproduction of the corresponding contents starts. After activation of the sub-contents, the flow returns to S840.

In S848, based on the received sub-contents termination information and the sub-contents termination determination information held by the sub-contents, whether the sub-contents can be terminated or not is determined, and the corresponding contents are terminated. After termination of the contents, the flow returns to S840.

In S852, the type of communication information is determined. If the communication information is the message request information, the flow proceeds to S854. If it is the message transmission information, the flow proceeds to S856.

S854 selects the requested contents based on the received message request information and the message request determination information held by the sub-contents, and issues a request for a message to the corresponding service. After requesting the message, the flow returns to S840.

In S856, the message to be transmitted by the sub-contents is selected based on the received message transmission information and the message transmission determination information held by the sub-contents, a message is formatted, and the message is transmitted to the corresponding service. After transmission of the message, the flow returns to S840.

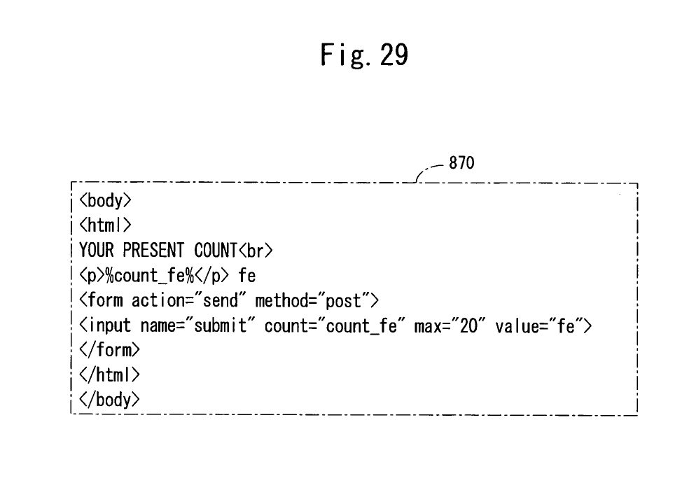

FIG. 29 shows an exemplary program (html document) when the information operated by the sub-contents are reflected on the message and transmitted to the service. Here, the display on region 791 of FIG. 25 is taken as an example. It is known from the “src” attribute of display contents designating information 684 of FIG. 23, that the document name of the html document displayed as the sub-contents is “personal.html”. The html text on FIG. 29 represents the contents of this document.

In the document “personal.html” of FIG. 29, in the <input> tag defining the “fe” button (button 793 of FIG. 25), there is a “count” attribute (count=“count_fe”). Here, when the button 793 is clicked, the number of clicks is counted, starting from zero, and the value is stored as a numerical value in the variable “count_fe” that is designated by the “count” attribute. The value is transmitted as the contents of the message, to broadcast-contents-combined service providing apparatus 614.

Specifically, returning to FIG. 23, sub-contents activation determination information 692 in sub-contents 650 includes an “input” tag that has the above-described variable “count_fe” as “value” attribute. Here, upon reception of “send_fe” as the sub-contents control information (message transmission information) designated by the “send” attribute, the value of variable “count_fe” is obtained from “personal.html” that has the variable “count_fe”.

In the example shown in FIG. 29, there is a “max” attribute in <input>. The “max” attribute represents the maximum value that can be input by this input. Specifically, in the present embodiment, the maximum number of clicks of the button is designated by the “max” attribute. In the present embodiment, the value of variable “count_fe” is limited to 20, even when the button is clicked more than 20 times.

The broadcast contents and sub-contents combined service is realized by the configuration described above.

<Operation>

The broadcast-contents-combined service system 600 in accordance with the second embodiment described above operates as follows, as will be described with reference to FIGS. 20 to 29.

Broadcast contents forming apparatus 60 forms broadcast contents including AV data for the program and the broadcast contents sub-data, and broadcasts the formed broadcast contents through relay station 72 in a prescribed time zone.

Sub-contents forming apparatus 612 transmits the sub-contents to portable terminal 622 through communication network 46.

Broadcast contents reproducing apparatus 620 receives the broadcast form relay station 72 and reproduces the contents. If the received broadcast contents includes broadcast contents sub-data, broadcast contents reproducing apparatus 620 transfers the data to sub-contents reproducing apparatus 630 of portable terminal 622 through the network 46 (such as wireless LAN). Sub-contents reproducing apparatus 630 reproduces the sub-contents, based on the transferred broadcast contents sub-data and the sub-contents that have been received and stored in advance from sub-contents forming apparatus 612.

At this time, when the viewer (user of portable terminal 622) clicks the button based on the displayed contents, the number of clicks is registered in the variable “count_fe” of sub-contents reproducing apparatus 630. When it comes to a prescribed time point designed in advance in the program, the message transmission information is applied to sub-contents reproducing apparatus 630 through relay station 72 and broadcast contents reproducing apparatus 620. In response to the message transmission information, sub-contents reproducing apparatus 630 forms a message based on the message structure data included in the sub-data and on the value of variable “count_fe”, and transmits the message to broadcast-contents-combined service providing apparatus 614. The message includes the number of clicks of the button (count_fe), personal information stored in advance for portable terminal 622, and information prescribed in the sub-contents (transmission destination information and the like).

Accordingly, program producer 602 having broadcast contents forming apparatus 60, sub-contents forming apparatus 612 and broadcast-contents-combined service providing apparatus 614 can count, collect or accumulate the information related to the program and to present the result to the audience, during or immediately after the broadcast of the TV program.

It is unnecessary for the user of the portable terminal 622 to input the message transmission destination. Therefore, it is easy for the user to use the service. Further, erroneous transmission resulting from erroneous input can be avoided. Still further, the message transmission destination is prepared in the sub-contents beforehand in association with the broadcast contents, and transmitted at a timing determined by the sub-contents control information (message transmission information or message request information) through the broadcast. Therefore, accumulative transmission of the message or transmission at an undesirable timing can be avoided.

[Variation]

In the first and second embodiments, a button “mail this to a friend” such as button 360 of FIG. 12 or button 796 of FIG. 25 may be prepared, in the sub-contents. This scheme can be formulated utilizing the method described above, in which the sub-contents that are enjoyed at present can be transmitted to a different portable terminal of the user or to a portable telephone terminal of a different user, by simply clicking the button.

In the second embodiment described above, the sub-contents are directly transmitted to the portable terminal 622 of the user. As in the first embodiment, the formed message may be transmitted to the broadcaster, and the user may receive the sub-contents together with the broadcast contents.

In the first and second embodiments above, it is assumed that the viewer watches the broadcast when the program is actually distributed. The present invention, however, is not limited to such an embodiment. By way of example, the scheme described above may be used when the broadcast may be stored in a storage medium such as an HDD and viewed in a time zone different from the actual time of distribution of the broadcast.

In the second embodiment described above, a message is automatically transmitted in response to the message transmission information distributed over the broadcast. Therefore, as compared with an approach in which the viewer determines the timing of transmission, untimely transmission of a message during the program or transmission of a message at an arbitrary time after the end of the program can be avoided. Therefore, transmission of messages unwanted by the program producer can be avoided. Further, the terminal that can be used is not limited to a portable terminal. Any device that has functions comparable to the portable terminal 48 described above may be used, no matter whether it is portable or not. For example, a TV receiver or a desktop PC may be used as the terminal. In the present embodiment, however, use of a portable telephone as the terminal 48 is preferred.

In the first and second embodiments described above, the sub-contents control information is text data separate from the broadcast contents. The sub-contents control information, however, is not limited to the text data, and it may be audio information or image information. Further, the sub-contents control information may be realized as sub-data that can be distinguished from the broadcast data, or it may be realized as data held in broadcast contents themselves. By way of example, text data displayed in the AV data, or audio information or image information included in the AV data may be used as the sub-contents control information. If the sub-contents control information is audio information or image information, sub-contents control determination information must be capable of determination as to the matching with the audio information or image information. The same applies to the message use information.

In the first and second embodiments, the broadcast contents sub-data are distributed to the viewer in association with the broadcast. Therefore, on the reproducing apparatus of the viewer, the broadcast contents and the sub-contents are combined, matched in time. Actually, while the broadcast contents are being reproduced, appropriate sub-contents are reproduced. The present invention, however, is not limited to such a form. Even when the data corresponding to the broadcast contents data does not accompany the broadcast contents, the invention may be realized in the manner as described below.

By way of example, the broadcast contents sub-data and the broadcast contents may not be packed. In that case, the operator providing the service using the broadcast-contents-combined service providing apparatus 64 determined in advance which sub-contents control information should be provided at which time to the reproducing apparatus, in order to realize combination with the broadcast contents. The broadcast contents are broadcast in the usual manner by the broadcaster. When the broadcast contents are actually broadcast, the service provider distributes the appropriate sub-contents control information at an appropriate timing through some means, such as the network. Naturally, it is necessary to distribute sub-contents that correspond to certain sub-contents control information prior to the distribution of the certain sub-contents control information.

By this configuration, it becomes possible for the viewer to obtain the sub-contents control information through a path different from that for the broadcast contents while enjoying the broadcast contents, and similar effects as in the first and second embodiments above can be attained. In this case, it is impossible to store the broadcast contents on a storage medium and to view the contents not on real time. By the following approach, however, it becomes possible to provide the associated sub-contents in synchronization with reproduction of the contents from the storage medium.

Here, as in the above-described embodiments, the sub-contents may be distributed in advance to the viewer. It is determined in advance when and which sub-contents control information should be distributed in relative time using the reproduction start time of contents as a reference, and the information is put in the broadcast-contents-combined service providing apparatus 614 or the like. When the user starts reproduction of contents from the storage medium, the user transmits information related to that time point to the service provider through the network. The apparatus of the service provider uses this time point as a start point, and distributes the expected sub-contents control information at a prescribed relative time therefrom. In this manner, similar to transmission of the sub-contents control information together with the broadcast contents over the broadcast on real time basis, synchronization between the contents and the sub-contents control information can be established. As a result, the same effects as in the two embodiments above can be attained.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. A sub-contents reproducing apparatus that reproducing, in association with first contents as a main object, prescribed sub-contents related to said first contents, wherein
sub-contents control information for designating reproduction control related to said sub-contents related to a prescribed timing when said first contents are reproduced is prepared in advance for said first contents;
said sub-contents reproducing apparatus comprising:
storing means for obtaining and storing said sub-contents simultaneously with or before distribution of the corresponding sub-contents control information;
first obtaining means for obtaining, when said first contents are reproduced, the sub-contents control information prepared in advance for the first contents; and
sub-contents control means responsive to said first obtaining means obtaining the sub-contents control information, for performing reproduction control corresponding to the obtained sub-contents control information on the sub-contents stored in said sub-contents storing means.

2. The sub-contents reproducing apparatus according to claim 1, wherein
said first obtaining means includes receiving means for receiving broadcast and separating, from the received broadcast, the sub-contents control information.

3. The sub-contents reproducing apparatus according to claim 1, wherein
said sub-contents may include one or a plurality of sub-contents data items;
said one or a plurality of sub-contents data items each include a piece of process specifying information for specifying a process on the sub-contents data item and a piece of trigger specifying information for specifying of the sub-contents control information acting as a trigger for executing the process, associated with each other; and
said sub-contents control means includes
determining means for determining whether said obtained sub-contents control information matches any of the pieces of trigger specifying information included in any of said one or a plurality of sub-contents data items, and
process executing means responsive to a determination by said determining means that said received sub-contents control information matches any of said pieces of trigger specifying information, for executing a process specified by the piece of process specifying information corresponding to said trigger specifying information on the sub-contents data item including the piece of process specifying information.

4. The sub-contents data reproducing apparatus according to claim 3, wherein
said determining means includes means for determining whether the sub-contents control information obtained by said first obtaining means matches a prescribed data string specified by any of said pieces of trigger specifying information or not.

5. The sub-contents reproducing apparatus according to claim 3, wherein
said determining means includes means for specifying, from said one or a plurality of sub-contents data items, the one having the piece of trigger specifying information matching the sub-contents control information obtained by said first obtaining means, and
said process executing means includes means for executing, on each of the sub-contents data items specified by said specifying means, a process specified by the piece of process specifying information associated with said one of the pieces of trigger specifying information included in the sub-contents data item matching said sub-contents control information.

6. The sub-contents reproducing apparatus according to claim 3, wherein
said process specifying information includes
sub-contents activation information designating activation of a corresponding sub-contents data item, and
sub-contents termination information designating termination of a corresponding sub-contents data item.

7. The sub-contents reproducing apparatus according to claim 6, wherein
said process specifying information further includes message transmission information that designates generation of a message including data generated from a corresponding sub-contents data item and transmission of the message to a prescribed transmission destination.

8. The sub-contents reproducing apparatus according to claim 6, wherein
said process specifying information further includes data obtaining information that designates obtaining a document specified by a corresponding sub-contents data item.

9. The sub-contents reproducing apparatus according to claim 6, wherein
said process executing means includes
means for activating, among the sub-contents data items specified by said specifying means, the one including a piece of trigger specifying information matching the obtained sub-contents activating process, independent from other sub-contents data items, and
means for terminating, among the sub-contents data items specified by said specifying means, the one including a piece of trigger specifying information matching the obtained sub-contents terminating process and having been activated by said activating means, independent from other sub-contents data items.

10. The sub-contents reproducing apparatus according to claim 2, further comprising
contents reproducing means for receiving broadcast received by said receiving means for reproducing contents of the broadcast.

11. A contents-related service providing system, comprising:
a contents providing apparatus providing first contents as a main object;
a contents reproducing apparatus for receiving said first contents provided by said contents providing apparatus and for reproducing the contents;
a sub-contents providing apparatus providing sub-contents related to said first contents; and
a sub-contents control information providing apparatus applying to said contents reproducing apparatus sub-contents control information acting as a trigger for a prescribed process on said sub-contents at a prescribed timing when said first contents are reproduced; wherein
said contents reproducing apparatus includes
storing means for obtaining and storing said sub-contents from said sub-contents providing apparatus simultaneously with or before distribution of the corresponding sub-contents control information,
obtaining means for obtaining, when said first contents are reproduced, the sub-contents control information corresponding to the first sub-contents from said sub-contents control information providing apparatus, and
sub-contents control mean responsive to said obtaining means obtaining the sub-contents control information, for performing reproduction control corresponding to the obtained sub-contents control information on the sub-contents stored in said sub-contents storing means.
